(19) United States
(12) Patent Application Publication
(10) Pub. No.: US 2026/0189291 A1
(43) Pub. Date: Jul. 2, 2026

(54) METHODS FOR RESOURCE DETERMINATION FOR BEAM FAILURE RECOVERY IN HIGHER FREQUENCY COMMUNICATIONS

(71) Applicant: INTERDIGITAL PATENT HOLDINGS, INC., Wilmington, DE (US)

(72) Inventors: Prasanna HERATH, Laval (CA); Young Woo KWAK, Woodbury, NY (US); Patrick TOOHER, Montreal (CA); Nazli KHAN BEIGI, Longueuil (CA); Haseeb UR REHMAN, Winnipeg (CA); Moon IL LEE, Melville, NY (US); Tejaswinee LUCHOOMUN, Montreal (CA); Yugeswar Deenoo NARAYANAN THANGARAJ, Chalfont, PA (US)

(73) Assignee: INTERDIGITAL PATENT HOLDINGS, INC., Wilmington, DE (US)

(21) Appl. No.: 19/116,849

(22) PCT Filed: Sep. 28, 2023
(86) PCT No.: PCT/US2023/034038

§ 371 Date: Mar. 28, 2025

Related U.S. Application Data
(60) Provisional application No. 63/410,958, filed on Sep. 28, 2022.

(51) Int. Cl. H04B 7/06; H04B 17/373

(52) U.S. Cl. CPC H04B 7/06964; H04B 17/373

(57) ABSTRACT

Methods for determining candidate beams for beam failure recovery are provided herein. A method performed by a wireless transmit/receive unit (WTRU) includes receiving configuration information for receiving a first set of reference signals that are associated with a first set of beams, receiving configuration information for receiving a second set of reference signals that are associated with a second set of beams, and one or more criteria for candidate beam selection. The method includes receiving at least one of the first set of reference signals. The method includes transmitting information indicating a selected third set of beams that satisfy the received criteria for candidate beam selection. The selected third set of beams is a suggested set of candidate beams to be monitored for beam failure recovery. The third set of beams is selected based on beam quality measurements of one of the first set of reference signals.

### CROSS-REFERENCE TO RELATED APPLICATIONS

This application claims the benefit of U.S. Provisional Application No. 63/410,958, filed Sep. 28, 2022, the contents of which are incorporated herein by reference.

### BACKGROUND

Beam failure detection and recovery are important functionalities in beam-based communication systems such as those operating in accordance with Third Generation Partnership Project (3GPP) Fifth Generation (5G) specifications. A wireless transmit/receive unit (WTRU) in such a system may monitor the quality of beam(s) in use through resources (such as beam failure detection resources). Alternative beam(s) may be selected out of a configured set of candidate beams when beam failure is detected.

In systems operating in accordance with Release 16 and Release 17 specifications, the candidate beams may be semi-statically configured for each WTRU by a base station (e.g., a base station). This type of configuration may require many candidate beams to support systems operating in higher frequency ranges, such as Frequency Range 2-2 (FR2-2), due to narrow beam width and due to the base station/WTRU's reliance on current or recent beam measurements for determining the candidate beams. Otherwise, the beam failure recovery process may very often fail to provide a suitable new beam. Using many candidate beams can, however, lower the system throughput due to the use of time division duplexing (TDD) in beam sweeping and increase power consumption in WTRUs.

To avoid the need for many candidate beams, it may be advantageous for WTRUs and base stations to support the use dynamic sets of candidate beams and use artificial intelligence/machine learning (AI/ML) based methods for beam predictions during a candidate beam determination process. Configuring a WTRU with a set of reference signals (e.g., a beam failure detection reference signal (BFD-RS) set) dynamically and selecting/configuring a WTRU with dynamic set of related parameters may improve the efficiency of a BFD procedure and reduce overhead.

### SUMMARY

A method executed by a wireless transmit/receive unit (WTRU) is provided for determining candidate beams for beam failure recovery. The method involves receiving configuration data for two sets of reference signals linked with two sets of beams and criteria for candidate beam selection. Upon reception of at least one reference signal from the first set of beams, the WTRU may communicate details designating a third set of beams. The third set, selected based on beam quality measurements from the received reference signal, may fulfill the specified criteria, and may serve as recommended candidate beams for beam failure monitoring and recovery.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a Venn diagram representation of a candidate beam set and a set of active candidate beams of the candidate beam set;

FIG. 3 is a diagram illustrating an example of a beam failure recovery procedure carried out by a base station and WTRU

FIG. 4 is a diagram illustrating an example of a beam failure recovery procedure carried out by a base station and a WTRU;

FIG. 5 is a Venn diagram representation of a candidate beam set determined according to the equation

$${\overline{q}}_{1 - total} , {\overline{q}}_{1}^{{R}_{i}} , i ∈ \{ 1 , 2 , … , N \} , {\overline{q}}_{1 - remaining} . {\overline{q}}_{1 - union} = {⋃}_{i = 1}^{N} {\overline{q}}_{1}^{{R}_{i}} ;$$

FIG. 6 is a diagram illustrating an example of a CFRA-BFR procedure carried out by a WTRU using location/time-based determinations of

$${\overline{q}}_{1}^{Active} ;$$

and

FIG. 7 is a flowchart illustrating steps as may be performed by a WTRU for FR2 candidate beam set determination through FR1 beam quality measurements using an AI/ML model.

### DETAILED DESCRIPTION

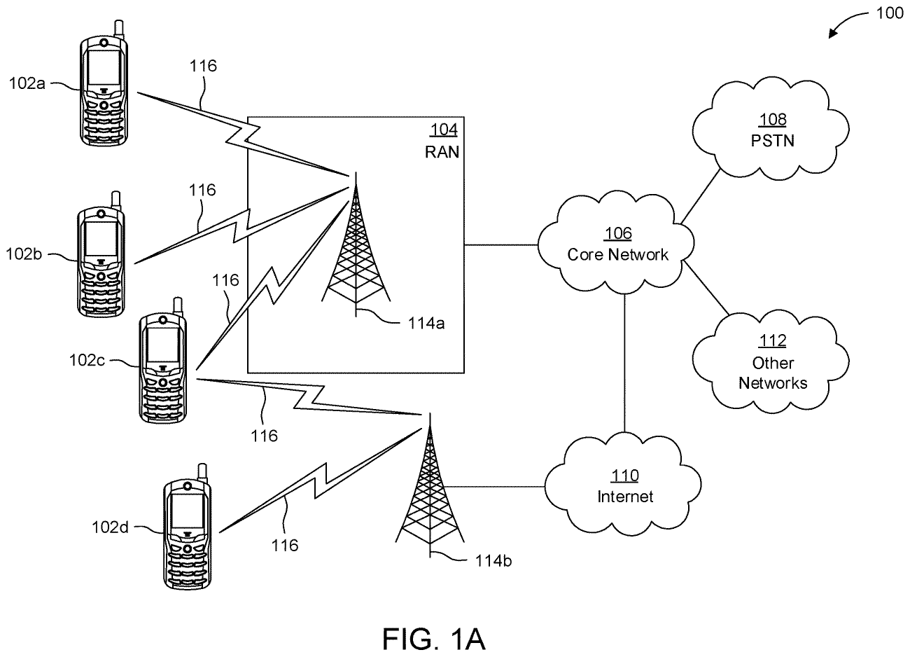

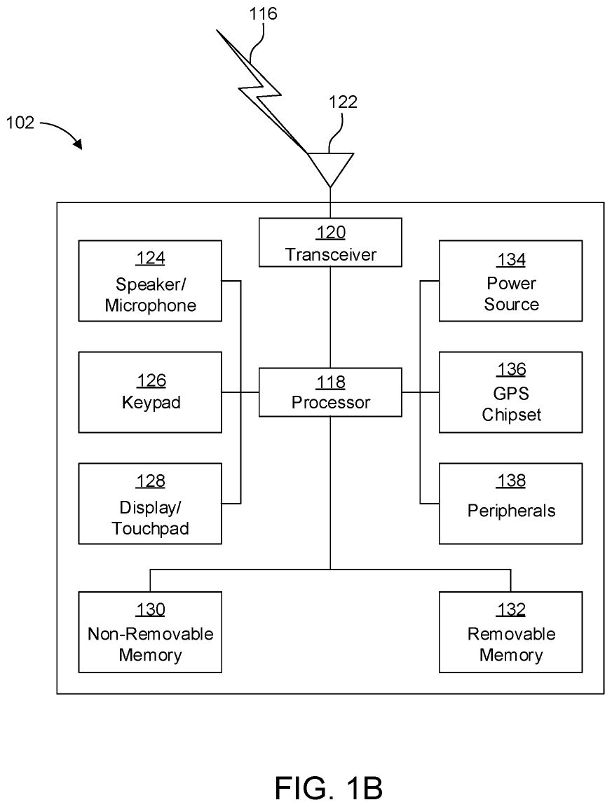

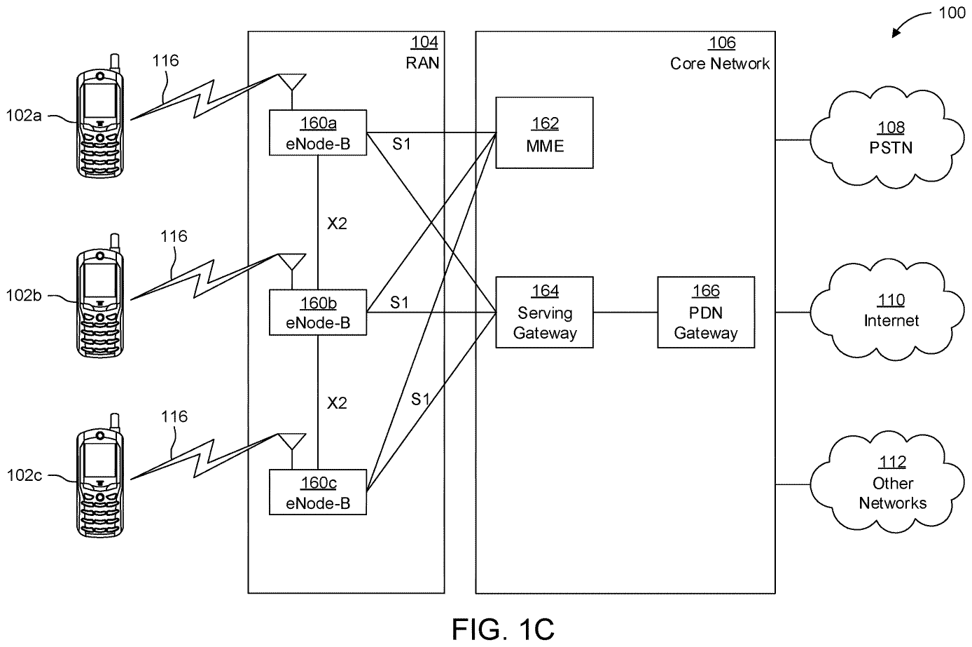

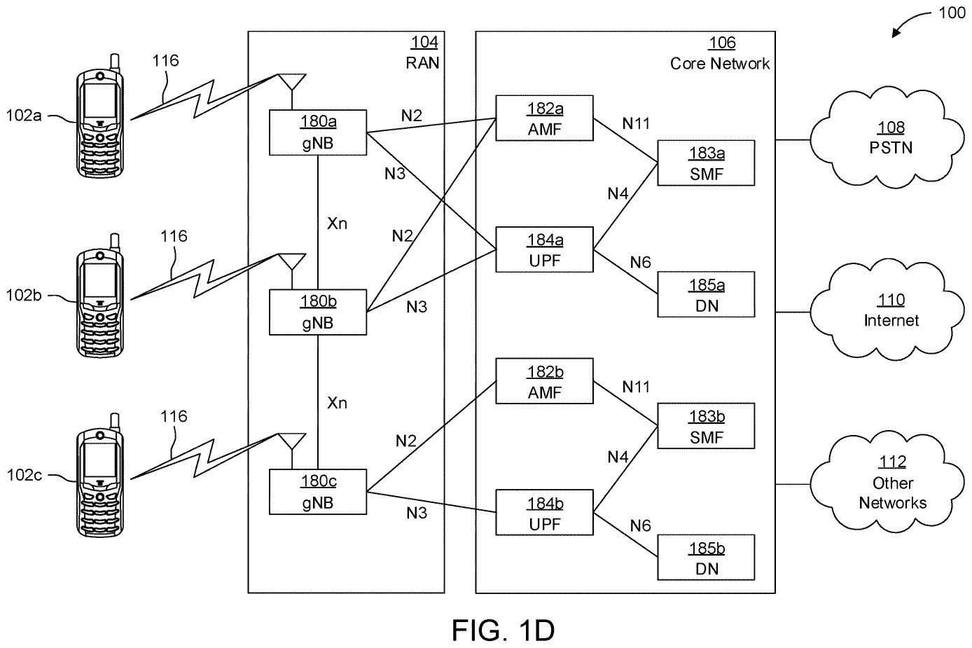

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (18-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various acronyms as may be used herein are set forth as follows:
Δf Sub-carrier spacing
K0 PDSCH scheduling offset in number of slots
K2 PUSCH scheduling offset in number of slots
U Set union
AP Aperiodic
BF Beam failure
BFR Beam Failure Recovery
BFD-RS Beam Failure Detection-Reference Signal
BLER Block Error Rate
BR Beam Resource
BWP Bandwidth Part
CA Carrier Aggregation
CB Contention-Based (e.g., access, channel, resource)
CBRA Contention-Based Random Access
CBRA-BFR CBRA-Beam Failure Recovery
CDM Code Division Multiplexing
CFRA Contention-Free Random Access
CFRA-BFR CFRA-Beam Failure Recovery
CG Cell Group
CoMP Coordinated Multi-Point transmission/reception
CP Cyclic Prefix
CPE Common Phase Error
CP-OFDM Conventional OFDM (relying on cyclic prefix)
CQI Channel Quality Indicator
CN Core Network (e.g., LTE packet core or NR core)
CORESET Control Resource Set
CRC Cyclic Redundancy Check
CSI Channel State Information
CSI-RS Channel State Information-Reference Signal
CU Central Unit
D2D Device to Device transmissions (e.g., LTE Sidelink)
DC Dual Connectivity
DCI Downlink Control Information
DL Downlink
DMRS Demodulation Reference Signal
DRB Data Radio Bearer
DU Distributed Unit
EN-DC E-UTRA—NR Dual Connectivity
EPC Evolved Packet Core
FD-CDM Frequency Domain-Code Division Multiplexing
FDD Frequency Division Duplexing
FDM Frequency Division Multiplexing
ICI Inter-Cell Interference
ICIC Inter-Cell Interference Cancellation
IP Internet Protocol
IRS Intelligent Reflecting Surface
LBT Listen-Before-Talk
LCH Logical Channel
LCID Logical Channel Identity
LCP Logical Channel Prioritization
LLC Low Latency Communications
LoS Line-of-Sight
LTE Long Term Evolution e.g., from 3GPP LTE R8 and up
MAC Medium Access Control
MAC-CE MAC Control Element
NACK Negative ACK
MBMS Multimedia Broadcast Multicast System
MCG Master Cell Group
MCS Modulation and Coding Scheme
MIMO Multiple Input Multiple Output
MTC Machine-Type Communications
MR-DC Multi-RAT Dual Connectivity
NAS Non-Access Stratum
NCB-RS New candidate beam-Reference Signal
NE-DC NR-RAN—E-UTRA Dual Connectivity
NLoS Non-Line-of-Sight
NR New Radio
NR-DC Dual Connectivity with
OFDM Orthogonal Frequency-Division Multiplexing
COB Out-Of-Band (emissions)
Pcmax Total available WTRU power in a given transmission interval
Pcell Primary cell of Master Cell Group
PCG Primary Cell Group
PDCCH Physical Downlink Control Channel
PDU Protocol Data Unit
PER Packet Error Rate
PHY Physical Layer
PLMN Public Land Mobile Network
PLR Packet Loss Rate
PRACH Physical Random Access Channel
PRB Physical Resource Block
PRS Positioning Reference Signal
PScell Primary cell of a Secondary cell group
PSS Primary Synchronization Signal
PT-RS Phase Tracking-Reference Signal
PUCCH Physical Uplink Control Channel
QoS Quality of Service (from the physical layer perspective)
RAB Radio Access Bearer
RAN PA Radio Access Network Paging Area
RACH Random Access Channel (or procedure)
RAR Random Access Response
RAT Radio Access Technology
RB Resource Block
RCU Radio access network Central Unit
RF Radio Front end
RE Resource Element
RIS Reconfigurable Intelligent Surface
RLF Radio Link Failure
RLM Radio Link Monitoring
RNTI Radio Network Identifier
ROM Read-Only Mode (for MBMS)
RRC Radio Resource Control
RRM Radio Resource Management
RS Reference Signal
RTT Round-Trip Time
SCG Secondary Cell Group
SCMA Single Carrier Multiple Access
SCS Sub-Carrier Spacing
SDU Service Data Unit
SOM Spectrum Operation Mode
SP Semi-persistent
SpCell Primary cell of a master or secondary cell group.
SRB Signaling Radio Bearer
SS Synchronization Signal
SRS Sounding Reference Signal
SSS Secondary Synchronization Signal
SUL Supplementary Uplink
SWG Switching Gap (in a self-contained subframe)
TB Transport Block
TBS Transport Block Size
TCI Transmission Configuration Index
TDD Time-Division Duplexing
TDM Time-Division Multiplexing
TI Time Interval (in integer multiple of one or more symbols)
TTI Transmission Time Interval (in integer multiple of one or more symbols)
TRP Transmission/Reception Point
TRPG Transmission/Reception Point Group
TRS Tracking Reference Signal
TRx Transceiver
UL Uplink
UE User Equipment
URC Ultra-Reliable Communications
URLLC Ultra-Reliable and Low Latency Communications
V2X Vehicular communications
WLAN Wireless Local Area Networks and related technologies (IEEE 802.xx domain)
WTRU Wireless Transmit/Receive Unit

Beam Failure Recovery Procedures for New Radio (NR) are described herein. In a beam failure recovery (BFR) procedure, a WTRU may continuously monitor a set of WTRU-specific periodic reference signals (RSs), for example a synchronization signal block (SSB) (also referred to herein as an SS/PBCH block) and/or channel state information-reference signal (CSI-RS), associated with the beams used for physical downlink control channel (PDCCH). In particular, for each bandwidth part (BWP) of a serving cell, a WTRU may be provided a set of periodic CSI-RS resource configuration indices and/or SS/PBCH block indexes (which may be referred to as a set q̅₀). The set of resource configuration indices or SS/PBCH block indices may be indicated in a message including one or more parameters, such as failureDetectionResources. If no RSs are provided for the purpose of beam failure detection, the WTRU may perform beam monitoring based on a RSs set indicated by, or associated with, an activated TCI-State for PDCCH reception. If there are two RSs associated with a TCI state, the set q̅₀ may include an RS index with QCL-TypeD configuration for each corresponding TCI state. When a measured beam quality of all WTRU-specific periodic RS set q̅₀ falls below a threshold a number of times (e.g., a number of times defined by a message or a parameter such as beamFailurelnstanceMaxCount) within a time interval (e.g., defined by a message or a parameter such as beamFailureDetectionTimer), the WTRU may declare beam failure and initiate a beam failure recovery procedure to identify an alternative candidate beam. The beam failure recovery procedure may be subject to a timer (e.g., a time duration defined by a message or a parameter such as beamFailureRecoveryTimer).

Alternative candidate beams may be selected from a set of WTRU-specific periodic RSs (e.g., SSB and/or CSI-RS) q̅₁, which may be configured by a message including parameters such as candidateBeamRSList or candidateBeamRSListExt, or candidateBeamRSSCellList. Such parameters may be indicated via a radio resource control (RRC) configuration message or another logically equivalent message. After finding a new beam, the WTRU may transmit a message, such as a beam recovery request and/or beam failure indication via a dedicated physical random access response channel (PRACH) to the base station. To this end, the base station may determine the candidate beam based on association between PRACH resources and periodic CSI-RS configuration index and/or SS/PBCH block indexes. After receiving the PRACH transmission, the base station may transmit a recovery response message to the WTRU. For example, the WTRU may be provided a dedicated set of resources (such as a CORESET) e.g., an indication of a search space set provided by a parameter such as recoverySearchSpaceId. Such RRC configuration information may be for monitoring PDCCH transmissions in the CORESET. The base station may transmit a PDCCH transmission through the CORESET confirming the new beam selection. If the response is successfully received by the WTRU, the beam recovery procedure may be considered successful, and a new beam pair link may be established. Otherwise, the WTRU may perform additional beam recovery requests by ramping up the transmit power of PRACH transmission. If this still fails, the WTRU may initiate contention-based RACH procedure, which possibly includes cell re-selection.

Beam Failure Recovery procedures for higher frequency communications (e.g., communications in FR2-2) are described herein. Higher frequency communications may be more susceptible to path loss than communications in lower frequencies. To compensate for the higher path loss, antenna gains are increased which may result in highly directive narrow beams. When using narrow beams, even a small movement and/or rotation of a WTRU or the movement of an object blocking radio wave propagation may make multiple candidate beams unsuitable for beam failure recovery. With this in mind, if candidate beams are semi-statically configured, as may be common in Rel-16/17, many may be configured to ensure the WTRU may find a new beam with sufficient quality in a beam failure situation. If the WTRU cannot find a new beam with sufficient quality, the WTRU may experience frequent radio link failure (RLF). However, if many candidate beams are used, throughput may be degraded as transmissions sent using candidate beams are transmitted in a TDM fashion. This may lead to excessive overhead of time/frequency resources. Further, monitoring many candidate beams may be problematic for battery powered user terminals due to increases in power consumption.

Several extensions are proposed herein to provide a more efficient beam failure recovery procedure that is more suitable for higher frequency communications. These extensions may include improvements that make the candidate beam set dynamic and using AI/ML based beam predictions in the candidate beam determination process.

Various problems addressed by embodiments herein are described as follows. Determining candidate beams based on past and current beam measurements may not be an efficient means of operation for a dynamic beam-based communication system, such as NR. To this end, some methods proposed herein may involve AI/ML based beam predictions, which may be used to predict future requirements/conditions. With such capabilities, candidate beam resources can be selected considering past, current, and predicted future requirements/conditions. To make this possible, several design problems may need to be overcome. These may include, but are not limited to: (1) how AI/ML based beam prediction capabilities can be used in the candidate beam determining process; (2) how a base station (or WTRU) determines to activate/deactivate AI/ML-based candidate beam determinations and indicate the activation/deactivation to the WTRU (or base station); (3) how a base station (or WTRU) monitors the performance of AI/ML based candidate beam sets and determines the need for a new candidate beam set; (4) how a base station (or WTRU) monitors the accuracy of AI/ML based candidate beam set determinations, identifies a need for AI/ML model training, and triggers or requests AI/ML model training; and (5) how a base station (or WTRU) determines candidate beams and indicates a determined candidate beam set to the WTRU (or base station).

In some solutions, group-based candidate beam set indication/configuration may be supported. This may, for example, enable dynamic configuration of candidate beam sets with manageable signaling overhead. To make use of a candidate beam determination procedure, several design problems need to be solved. These include but are not limited to: (1) how group-based candidate beam configuration can be used to enhance AI/ML assisted candidate beam determination process; and (2) how to determine BFR related parameters when group-based candidate beam configuration is used.

Another design problem associated with BFR may be how to select an appropriate BFD-RS set. To make this possible, several further design problems may need to be solved. These may include, but may not be limited to: (1) how a WTRU may determine/be configured with a BFD-RS set dynamically; and (2) how a WTRU may determine/be configured with parameters related to BFD dynamically.

Proposed solutions that may address one or more of the above-described problems are described herein. Some solutions may enable a WTRU to be configured for and perform BFR with a dynamic candidate beam set. Some solutions may enable a WTRU to be configured for and perform BFR with a dynamic candidate beam set of a first type of beams (e.g., FR2 beams) based on beam predictions and/or measurements associated with a second type of beams (e.g., FR1 beams). Some solutions may enable a WTRU to be configured with a candidate beam set that includes the best candidate beam in terms of measured and/or predicted beam quality (e.g., L1-RSRP) with a configured level of probability. Some solutions may enable a WTRU to be configured and perform BFR with a dynamic candidate beam set based on predictions and/or measurements of one or more beam quality parameters (e.g., PMI, CQI, RI, L1-RSRP, SINR, RSRQ). Some solutions may enable a WTRU to be configured and perform BFR with a dynamic candidate beam set based on WTRU's location and/or time. Some solutions may enable a WTRU to determine the availability of candidate beams set of a secondary cell based on current beam quality measurements and/or predicted beam quality in a future time interval.

A “beam” may be defined or understood as follows. A radio beam may be conceptualized as a concentrated stream of radio waves that is directed in a specific direction. A beamformed transmission may be generated with a direction and narrowness that can be controlled to target specific receivers or areas, allowing for efficient use of the radio spectrum and reduced interference with other transmissions. A WTRU may transmit or receive a physical channel or reference signal according to at least one spatial domain filter. Thus, the term “beam” may be used to refer to a spatial domain filter used to send transmissions in a beamformed pattern.

A WTRU may derive transmit beamforming parameters based on receive parameters. A WTRU may transmit a physical channel transmission or signal using a same spatial domain filter as a spatial domain filter used for receiving an RS (such as CSI-RS) or a synchronization signal (SS) block. The WTRU transmission may be referred to as “target”, and the received RS or SS block may be referred to as “reference” or “source”. In such case, the WTRU may be said to transmit a target physical channel or signal according to a spatial relationship with a reference to such RS or SS block.

In some examples, the WTRU may transmit a first physical channel transmission or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relationship with a reference to the second (reference) physical channel or signal.

A spatial relationship may be implicit or configured or signaled by messaging (e.g., RRC, MAC-CE, or DCI). For example, a WTRU may determine implicitly to transmit a PUSCH transmission and DM-RS using the PUSCH according to the same spatial domain filter as used to transmit SRS. The WTRU may determine the spatial domain filter as one indicated by an n SRS resource indicator (SRI) carried in messaging such as DCI or configured by RRC. In some examples, a spatial relationship may be configured by RRC for an SRI or signaled by a MAC-CE for a PUCCH transmission. Such spatial relationship may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. In some circumstances, such as when the first and second signals are reference signals, an association may exist when the WTRU is configured with a quasi-colocation (QCL) assumption type D between corresponding antenna ports. Such association may be configured as a transmission configuration indicator (TCI) state. A WTRU may receive an indication of an association between a CSI-RS or SS block and a DM-RS. The indication may be provided by an index that is associated with a set of TCI states configured by RRC and/or signaled by MAC-CE. Such indication may also be referred to as a“beam indication”.

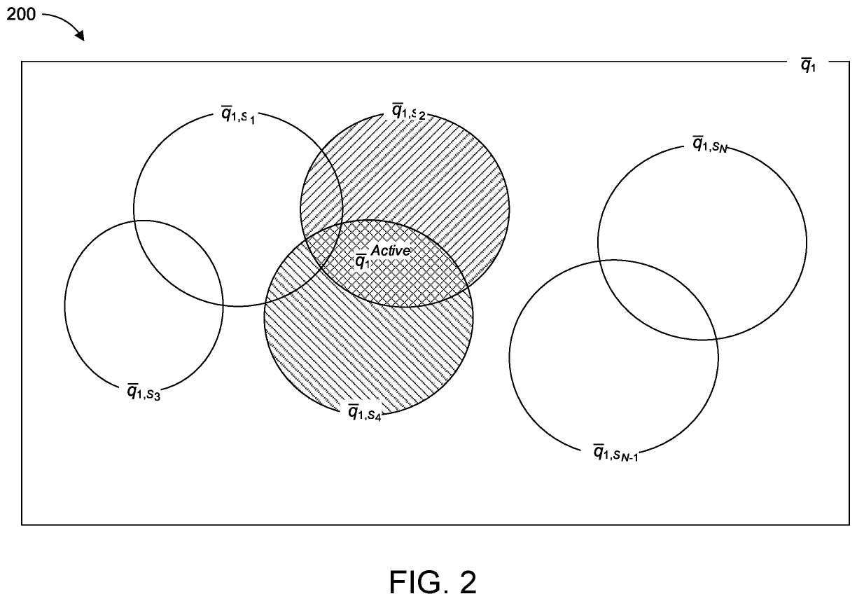

FIG. 2 is a Venn diagram representation of a candidate beam set and a set of active candidate beams of the candidate beam set. The candidate beam set 200 as shown in FIG. 2 is denoted by q̅₁. In the description of examples provided herein, candidate beam grouping can be used, substantially as shown in FIG. 2. That is, configured candidate beams of

$${\overline{q}}_{1} ( {\overline{q}}_{1}^{( 1 )} , {\overline{q}}_{1}^{( 2 )} , … , {\overline{q}}_{1}^{( M )} )$$

may be grouped creating N subsets of candidate beam set denoted by q̅_{1,S}_{₁}, q̅_{1,S}_{₂}, . . . q̅_{1,S}_{_{N}}. A particular beam or grouping of beams within q̅₁ may therefore be denoted by q̅_{1,S}_{ᵢ}, i∈{1, 2, . . . , N}. A grouping of beams may contain multiple or only a single beam. As is further shown in FIG. 2, for instance, q̅_{1,S}_{₁}, q̅_{1,S}_{₂}, . . . , q̅_{1,S}_{_{N}}, may have common beams (e.g., one or more beams that belong to one subset of candidate beams may also belong to one or more other subsets of candidate beams). A WTRU that is configured to performed BFR procedures may further be configured with the set of active candidate beams of the candidate beam set, which is denoted in FIG. 2 as

$${\overline{q}}_{1}^{Active} .$$

For example, a WTRU may receive an indication from a base station, and/or the WTRU may determine, to activate a selected set of candidate beam groups, i.e., q̅_{1,Si}, i∈S_{Active}, at a time (in the example configuration as shown in FIG. 2, S_{Active}∈{2,4}). The WTRU may perform BFR using the activated candidate beam(s) or beam set(s) denoted by

$${\overline{q}}_{1}^{A c t i v e} ( {\overline{q}}_{1}^{Active} = {⋃}_{i ∈ {S}_{Active}} {\overline{q}}_{1 , S i} ) .$$

Examples of group-based candidate beam set indication and determinations/configurations of BFR-related parameters are described herein.

A WTRU may make determinations as to the active candidate beam set

$$( {\overline{q}}_{1}^{Active} )$$

substantially as described in the following paragraphs. In some examples, a WTRU may receive configuration information for a candidate beam set q̅₁ (e.g., via RRC signaling or other logically equivalent signaling). The WTRU may, in some cases, receive configuration information indicating a subset of beams in q̅₁. For example, the WTRU may receive information indicating beam sets q̅_{1,S1}, q̅_{1,S2}, . . . , q̅_{1,S}_{_{N}}. The WTRU may, in some cases, receive information that activates or deactivates group-based candidate beam determinations. For example, the information activating or deactivating group-based candidate beam determinations may be a 1-bit indication carried via a MAC-CE or DCI, though conceivably other messaging may be used.

When the WTRU only receives an indication of q̅₁, but not q̅_{1,S}_{ᵢ}, i∈{1, 2, . . . , N}, the WTRU may determine the active candidate beam set includes all candidate beams of

$${\overline{q}}_{1} , i . e . , {\overline{q}}_{1}^{Active} = {\overline{q}}_{1} .$$

The WTRU may perform BFR using

$${\overline{q}}_{1}^{Active}$$

as the candidate beam resource set for BFR.

When the WTRU is configured with a subset of beams q̅_{1,S}_{ᵢ}, i∈{1, 2, . . . , N}, but is not configured to perform activated group-based candidate beam determination,

$${\overline{q}}_{1}^{Active} = {\overline{q}}_{1} ,$$

the WTRU may perform BFR using

$${\overline{q}}_{1}^{Active}$$

as the candidate beam resource set for BFR.

If the WTRU receives information activating group-based candidate beam determinations and configuration information indicating q̅₁, q̅_{1,S}_{ᵢ}, i∈{1, 2, . . . , N}, as well as selected set of candidate beams or beam groups, i.e., q̅_{1,Si}, i∈S_{Active}, the WTRU may perform BFR (e.g., CFRA-BFR) using the active candidate beams denoted by

$${\overline{q}}_{1}^{Active} where {\overline{q}}_{1}^{Active} = {⋃}_{i ∈ {S}_{Active}} {\overline{q}}_{1 , Si} .$$

Examples of BFR related parameter determinations are described in the following paragraphs. In some examples, a WTRU may determine one or more beam failure recovery related parameters based on configured parameters for q̅_{1,S}_{ᵢ}, i∈{1, 2, . . . , N}. These BFR related parameters may include but are not limited to time durations or timers (e.g., beamFailureRecoveryTimer), thresholds for assessment of beam quality (e.g., rsrp-ThresholdSSB or rsrp-ThresholdBFR), different priority configurations (e.g., prioritization/ra-PrioritizationTwoStep), transmit power/power ramping parameters used for transmitting BF indications (e.g., transmit power/power ramping up steps for transmitting preambles associated with new beams).

In some examples, a WTRU may first receive BFR related parameters for q̅₁ (e.g., via RRC configuration message(s) or via other logically equivalent signaling). The WTRU may subsequently receive BFR related parameter configuration information for one or more q̅_{1,S}_{ᵢ}, i∈{1, 2, . . . , N} (e.g., via MAC-CE or DCI, or other logically equivalent messages). When configured, BFR related parameters of q̅_{1,Si}, configured in the second step, may overwrite the parameters configured for q̅₁ in the first step.

In some examples, when a WTRU is configured with one q̅_{1,Si} for candidate beam set, i.e., the cardinality of S_{Active} is 1 (|S_{Active}|=1), the WTRU may perform BFR based on the parameters associated with the configured q̅_{1,Si}. If the WTRU is configured with more than one q̅_{1,Si} for BFR, i.e., |S_{Active}|>1, the WTRU may determine BFR related parameters considering parameters associated with all beams, or considering parameters associated with specific beams indicated by q̅_{1,Si} i∈{1, 2, . . . , N}.

In some example configurations, a WTRU may be configured with q̅_{1,S1} and q̅_{1,S2} (S_{Active}∈{1, 2}), each with different timing parameters or time durations (e.g., timer1, and timer2). In such cases, the WTRU may perform BFR assuming

$${\overline{q}}_{1}^{Active} = {\overline{q}}_{1 , S 1} ⋃ {\overline{q}}_{1 , S 2}$$

and determining that the time duration is a minimum of the configured time parameters (i.e., where timer=min{timer1, timer2}). Alternatively, or additionally, the WTRU may configured to determine a time duration based on a maximum of the configured time parameters (i.e., where timer=max{timer1, timer2}).

In some solutions, the WTRU may receive priority information associated with each of the indicated beams q̅_{1,Si} i∈{1, 2, . . . , N} (for example, via RRC configuration, MAC-CE or DCI, or via other logically equivalent signaling). The WTRU may give precedence to parameters associated with higher priority beams of q̅_{1,Si} when determining BFR related parameters. For example, one scenario may involve a beam set with two active beams (i.e., S_{Active}∈{1, 2}). In this case, q̅_{1,S}_{₁} may be associated with a first parameter (e.g., a time duration defined by timer1) and q̅_{1,S}_{₂} may be associated with a second parameter (e.g., a time duration defined by timer2). The WTRU may receive configuration information indicating q̅_{1,S}_{₂} has higher priority compared to q̅_{1,S}_{₁}. In such a scenario, the WTRU may perform BFR with

$${\overline{q}}_{1}^{Active} = {\overline{q}}_{1 , S 1} ⋃ {\overline{q}}_{1 , S 2}$$

and utilize the time duration indicated by timer2 based on the higher priority of q̅_{1,S}_{₂}.

Solutions for BFR with

$${\overline{q}}_{1}^{Active}$$

are described in the following paragraphs. In some solutions, a WTRU may perform a BFR procedure (e.g., find a new candidate beam and indicate the determined new candidate beam with CFRA) using

$${\overline{q}}_{1}^{Active}$$

and determined BFR related parameters using one or a combination of the following steps.

The WTRU may monitor a beam quality (e.g., L1-RSRP, SINR, or another beam quality metric) of candidate beam resources of

$${\overline{q}}_{1}^{Active} .$$

A WTRU may initiate monitoring of candidate beams, for example, upon the detection of a beam failure or one or more beam failure instances. Alternatively, the WTRU may monitor candidate beams periodically. The periodicity for beam monitoring may be configured by the base station. For example, a monitoring periodicity may be configured as a×periodicity of

$${\overline{q}}_{1}^{Active}$$

where a is dynamically indicated via a MAC-CE or DCI, or other logically equivalent messaging. A default value of a (e.g., a=1) may be configured, for example, using RRC messaging or another logical equivalent.

The WTRU may select a beam based on a measured beam quality (e.g., L1-RSRP, SINR, or another beam quality metric) as the new beam (e.g., a beam having the highest measured quality). The WTRU may indicate its selection to the base station.

The WTRU may indicate beam failure and indicate its selected new beam by transmitting a preamble corresponding to the beam (e.g., associated with a preamble occasion selected from

$${\overline{q}}_{1}^{Active} .$$

The WRTU may monitor BFR-CORESET for confirmation from the base station. In the case WTRU receives a transmission from the base station confirming reception of the preamble transmitted using the selected beam, the WTRU may select the new beam for subsequent transmission/reception and terminate the BFR process.

In the case the WTRU does not receive confirmation within a monitoring window duration, which may be determined using the BFR parameter determining procedures described substantially as in paragraphs above, the WTRU may attempt to retransmit the preamble after increasing the transmit power. The WTRU may determine the increase of transmit power based on the BFR related parameter determination procedure described substantially in paragraphs above. In the case the WTRU fails to receive confirmation as its the new beam selection after a number of attempted retransmissions, the WTRU may perform CBRA-BFR. The WTRU may receive configuration information indicating a limit on the number of attempted retransmissions, or implicitly derive a limit on the number of attempted retransmissions.

In some cases, if the WTRU determines that none of the beams in

$${\overline{q}}_{1}^{Active}$$

satisfies a beam quality threshold measurement, the WTRU may perform CBRA-BFR.

AI/ML-assisted methods for determination of the active candidate beam set,

$${\overline{q}}_{1}^{Active} ,$$

are described herein. In at least some of the methods proposed herein, an active candidate beam set may be determined for FR2 via beam predictions based on FR1 beams. The configuration of candidate beam subsets and associated beams across frequency ranges is described in the following paragraphs.

In some examples, a WTRU may be configured with a first set of beams including all possible candidate beams. The WTRU may alternatively, or additionally, be configured with one or more subsets of the first set of beams (q̅_{1,Si}). The subsets of beams may include one or more beams (q̅₁). Consistent with the description of examples herein, a “subset” or “group” of beams may conceivably represent a single beam.

The WTRU may be configured with an association between one or more subset of beams with one or more beam resource set(s). The beam resource set(s) may point to resources located in a different frequency region (FR) than where the beams operate. For example, the WTRU may be configured with one or more subsets of beams in FR2, and each subset of beams in FR2 may be associated with a beam resource set in FR1. A FR1 beam resource may be associated with one or more FR2 beams or subset of beams.

The configuration of the subset(s) of beams, beam resource configuration and association between beams of different FRs may be received by the WTRU via dynamic (e.g., L1 or MAC or other logical equivalents) signaling or semi-static (e.g., RRC) signaling. In some methods, a WTRU may determine an association between a subset of beams in a first FR and a beam resource in a second FR. The WTRU may send an indication of the association to a base station, e.g., via dynamic (e.g., L1 or MAC) signaling or semi-static (e.g., RRC) signaling.

Examples of methods involving blockage predictions are described in the following paragraphs.

In some examples, a WTRU may determine whether a beam or a subset of beams will suffer from an impediment. An impediment may include at least one of: blockage, poor performance (e.g., HARQ performance), fast or slow fading, change in AoA/AoD, switch from LoS to NLoS (or vice versa), or change in signal quality such as SINR or RSRP or RSRQ or CQI. Although various examples herein may refer specifically to a blockage or blockage probability, it should be understood that such examples may be applicable to any other type of impediment.

A WTRU may perform blockage predictions on one beam, one or more subset of beams, or all beams. In some examples, a blockage prediction may refer to a determination that one beam, a subset of beams, or all beams, is/are suffering from a blockage. This may include the start time of the blockage and the predicted duration or end time of the blockage. A blockage prediction may refer to a determination that one beam, a subset of beams, or all beams will suffer from a blockage. A blockage prediction may involve a determination of a predicted start time, duration, and/or end time of the blockage. A blockage prediction may include a determination that one beam, a subset of beams, or all beams, are likely to suffer from a blockage. A blockage prediction may include a determination of the probability that one beam, a subset of beams, or all beams are likely to suffer a blockage. This may include one or more blockage probabilities, each associated with a different time instance, where a time instance may include a set of symbols, slots, or may be defined by another time interval.

A WTRU may be configured with an AI/ML model to make a blockage prediction. For example, the WTRU may be configured to perform localized computations to apply and integrate an AI/ML model without inducing latency from the network. For example, this may enable more rapid decisions for beam management and beam selection in communication using higher frequencies, in which large numbers of beams are used. The WTRU and/or the network may be configured to periodically (or upon request) retrain the AI/ML model using data collected by the WTRU, by other WTRUs, or by the network. Alternatively, in some cases, a network node (such as a base station, a core network node, or another network entity) may be configured to execute an AI/ML model for blockage predictions.

A WTRU may perform blockage predictions for one beam, a subset of beams, or all beams using one or more beam resources (or beam resource set). The beam resource set used for blockage prediction may be located in the same FR as the FR where the concerned beams are configured (e.g., FR2), or the beam resource set used for blockage prediction may be in a different FR than the FR where the concerned beams are configured (e.g., resource set in FR1 and subset of beams configured with FR2). The WTRU may perform blockage prediction for a subset of beams on a first beam resource (or beam resource sets) in a first FR and a second beam resource (or beam resource sets) in a second FR.

The WTRU may use various parameters to perform blockage prediction. The parameters may be configured (e.g. via RRC signaling or other logically equivalent signaling) or indicated (e.g. via DCI or MAC-CE, or other logically equivalent messages). The parameters may include one or more of period and/or time offset information. For example, a WTRU may perform periodic blockage predictions using a configurable period and/or time offset. The periodicity and/or time offset of the blockage prediction may be determined based on a periodicity and/or time offset associated with the beam resources (e.g., the beam resource set) or based on resources used to feedback blockage predictions.

The parameters used for blockage predictions may include a duration of a blockage. For example, a WTRU may be configured with a minimum amount of time for which a blockage may be detected before a WTRU may declare a blockage is predicted. The amount of time may be measured, for example, in terms of a known time metric such as symbols, slots, or milliseconds, or frame/subframe. For example, a WTRU may declare that a blockage is predicted if the putative blockage is determined, predicted, or measured to last for at least x milliseconds.

The parameters used for blockage predictions may include a tolerable blockage probability threshold. For example, a WTRU may be configured with a maximum tolerable blockage probability threshold beyond which the WTRU may declare a blockage is predicted. In other words, if the WTRU determines that a blockage may occur with a level of probability that exceeds the tolerable blockage probability threshold, the WTRU may declare that a blockage has been predicted.

The parameters used for blockage predictions may include a tolerable blockage duration threshold. For example, a WTRU may be configured with a maximum tolerable blockage duration threshold, beyond which, the WTRU may declare a blockage is predicted. In other words, a tolerable blockage probability threshold may define a length of time for which a predicted blockage may not trigger the WTRU to declare that a blockage is predicted.

The parameters used for blockage predictions may include a blockage prediction confidence threshold. A confidence threshold may be a predefined limit or value that may be used to determine whether the blockage prediction can be deemed reliable or actionable. For example, if a blockage prediction is made with a confidence level that exceeds a configured confidence threshold, the WTRU may confirm its classification of the blockage prediction. On the other hand, if a blockage prediction is made with a confidence level that does not meet the configured confidence threshold, the WTRU may be configured to not declare that a blockage is predicted.

The parameters used for blockage predictions may include a validity time period. For example, a WTRU may determine that a subset of beams is valid for use (i.e., not suffering from a blockage) and the validity may be associated with a validity time period. Alternatively, or additionally, a validity time may be configured to apply to beam blockage predictions, such that a prediction that one or more beams are experiencing blockages or will experience blockages in the future is valid only during the validity time period.

The parameters used for blockage predictions may include activation and/or deactivation criteria. For example, a WTRU may receive an activation (or deactivation) indication to begin (or cease) monitoring one or more beams, one or more subsets of beams, or all beams to make blockage prediction. In some examples, a WTRU may determine to begin (or stop) monitoring one or more beams, one or more subsets of beams, or all beams to make blockage predictions based on at least one of: a measurement value (e.g. RSRP, SINR, RSRQ, RSSI, CO, CQI, RI, PMI, delay spread, doppler spread, mean delay, mean doppler, AoA/AoD, LOS/NLOS, or another metric), a time duration since (or a time instance of) a last or previous blockage prediction, a change of beam sets, mobility, speed, position, priority of data in a buffer, activation/deactivation of carriers, change of BWPs, or activation/deactivation/configuration/triggering information associated with beam resource(s) or beam resource set(s), or resource(s) for reporting beam measurements and/or blockage predictions.

Methods for selection of beams (e.g., subsets of beams) for an active candidate beam set are described herein.

In some examples, a WTRU may be configured with multiple subsets of beams. The WTRU may determine an active candidate set of beams

$$( {\overline{q}}_{1}^{Active} )$$

according to one or more methods described herein. An active candidate set of beams may refer to beams (or associated measurement resources) that the WTRU may monitor or perform measurements on when suffering from beam failure on one or more beams. The WTRU may determine the active candidate set of beams as a union, concatenation, and/or superset of one or more subsets of beams. An active candidate set of beams may include a subset of the first set of beams (which may cover all possible candidate beams).

A WTRU may determine that one or more beams, or a subset of beams, may be included in an active candidate set of beams if it satisfies one or more of the following criteria. It should be understood by those of skill in the art that the foregoing list of criteria is not exhaustive, and the active candidate set of beams may be determined based on other criteria not listed in the paragraphs that immediately follow.

An example of a criterion may be that a blockage probability is below a threshold. For instance, the blockage probability of the subset of beams may be determined as an average or maximum or minimum value of the blockage probabilities of beams of the subset of beams.

An example of a criterion may be that a subset of beams has at least x beams satisfies a blockage probability threshold, where x may be configurable and/or where satisfying a blockage probability threshold may mean that the blockage probability of the beam is less than the blockage probability threshold.

An example of a criterion may be that the subset of beams has the most beams satisfying a blockage probability threshold. For example, a WTRU may be configured with multiple subsets of beams, and the WTRU may select an active candidate set that includes the subset of beams that has the most beams whose blockage probability is less than a blockage probability threshold.

An example of a criterion may be that the a subset of beams that is to be included in the active candidate beam set includes a “best” beam or beams. For example, a WTRU may select one or more “best” beams per configured subset of beams and the active candidate beam set may include the union of these “best” beams. In some circumstances, the “best” beam may be determined as a beam having a lowest blockage probability. The “best” beam may be determined as the beam with the smallest blockage duration. The “best” beam may be determined as a beam that has not experienced a blockage, is not currently experience blockage, and/or is not predicted to experience blockage.

An example of a criterion may be that a blockage duration is below a threshold. In some examples, such as where the subset includes multiple beams, the blockage duration of the subset of beams may be determined as an average or maximum or minimum of the blockage durations of the beams in the subset of beams.

An example of a criterion may be that the subset of beams has at least x beams satisfying a blockage duration threshold, where x may be configurable and/or where satisfying a blockage duration threshold may mean that the blockage duration of the beam is less than the blockage duration threshold.

An example of a criterion may be that the subset of beams has the most beams satisfying a blockage duration threshold. For example, a WTRU may be configured with multiple subsets of beams and the WTRU may select an active candidate beam set that includes the subset of beams that has the most beams whose blockage duration is less than a blockage duration threshold. Another example of a criterion may be that a selected subset of beams or a selected beam satisfies a prediction confidence threshold.

Triggers for selection of a new active candidate beam set are described herein. A WTRU may be configured with an active candidate beam set, and a WTRU may select a new active candidate beam set when triggered to do so. In some examples, a new active candidate beam set may be the same as a previous active candidate beam set.

A WTRU may be triggered to select a new active candidate beam set based on various conditions or occurrences. In some examples, the WTRU may be triggered to select a new active candidate beam set at a given time. For instance, a WTRU may select a new active candidate beam set at time instances determined based on a period and/or offset values. The period and/or offset values may be configurable or may be derived implicitly.

The WTRU may be triggered to select a new active candidate beam set by a base station. A WTRU may receive a triggering indication from a base station to obtain anew active candidate beam set. The triggering indication may be received via signaling such as DCI, MAC-CE, RRC, or other logically equivalent signaling. The triggering indication may be received implicitly and/or may be assumed upon the reception of another signal providing information such as a beam change indication, HARQ-ACK feedback, cell activation/deactivation indication, BWP change indication, handover command, or system information.

The WTRU may be triggered to select a new active candidate beam set based on a validity time period. For example, a WTRU may select a new active candidate beam set if a validity time period of a previous active candidate beam set has elapsed. The validity time may be measured in symbols, slots or milliseconds.

The WTRU may be triggered to select a new active candidate beam set based on measurements of a current or previous active candidate beam set. For example, the WTRU may perform measurements on at least one beam of a current or previous active candidate beam set (or on at least one measurement resource associated with one beam in the active candidate beam set). A WTRU may determine, based on at least one measurement, that one or more beams or subset of beams in the current or previous active candidate beam set is no longer valid. For example, a WTRU may track blockage conditions such as a blockage probabilities or duration or timing of the beams in the active candidate beam set. If blockage conditions worsen (e.g., a blockage probability, duration, or timing becomes worse than is permissible), the WTRU may be triggered to select a new active candidate beam set. In some examples, if more than Y beams or a subset of beams in the active candidate beam set have a blockage probability or duration greater than a threshold value, the WTRU may be triggered to select a new active candidate beam set. In the aforementioned example, Y may be configurable or may be determined, for example, as a function of a size of the active candidate beam set.

The WTRU may be triggered to select a new active candidate beam set based on a metric of a subset of beams. For example, a WTRU may maintain metrics or measurements associated with one or more beams or subsets of beams included in the currently active candidate beam set and outside of the currently active candidate beam set. If a metric (e.g. blockage probability, blockage duration) or a measurement (e.g. SINR, RSRP, RSSI, RSRQ, CQI, RI, PMI, AoA/AoD, delay spread, doppler spread, average delay, average doppler, CO) associated with one or more beams, or a subset of beams (e.g. a subset of beams not included in the active candidate beam set), becomes greater than or lower than a metric or measurement of the currently active candidate beam set or a subset of beams in the currently active candidate beam set, the WTRU may be triggered to select a new active candidate beam set. For example, the WTRU may be triggered to select the new active candidate beam set if the metric or measurement associated with one or more beams or subsets of beams is greater or lower, by an offset value, than a corresponding metric or measurement associated with the currently active beam set. The offset value may be selected by the WTRU, configured or implicitly derived by the WTRU.

Indications concerning the active candidate beam set are described herein. A WTRU may indicate to the base station that an active candidate beam set is no longer valid. For example, when a trigger for selecting a new active candidate beam set (as listed above) is satisfied, the WTRU may indicate to the base station that an active candidate beam set is no longer valid. The indication may be provided via UCI, PRACH transmission (e.g., preamble), PUSCH transmission, PUCCH transmission, MAC-CE, RRC signaling, SRS transmission, PRS transmission or another logically equivalent transmission.

A WTRU may indicate to the base station that it has selected a new active candidate beam set. For example, upon selecting a new active candidate beam set, the WTRU may indicate the new active candidate beam set to the base station. The indication may be provided via UCI, PRACH transmission (e.g., preamble), PUSCH transmission, PUCCH transmission, MAC-CE, RRC signaling, SRS transmission, PRS transmission, or another logically equivalent transmission.

A WTRU may indicate to the base station that an active candidate beam set remains unchanged. For example, the WTRU may periodically report to the base station whether it has been triggered to select a new active candidate beam set. If the WTRU has not selected a new active candidate beam set, the WTRU may report that the set is unchanged. If the WTRU has selected a new active candidate beam set, the WTRU may report that the set is changed along with parameters of the new active candidate beam set. The indication may be provided via UCI, PRACH transmission (e.g., preamble), PUSCH transmission, PUCCH transmission, MAC-CE, RRC signaling, SRS transmission, PRS transmission, or another logically equivalent transmission.

When a WTRU indicates that a new active candidate beam set has been selected, the WTRU may include one or more of the information described in the following paragraphs. In some examples, the WTRU may include a time of the new active candidate beam set activation, or previous set deactivation.

In some examples, the WTRU may include contents of the active candidate beam set. The contents may include the one or more subset of beams whose union form the active candidate beam set. The contents of the active candidate beam set may be indicated via indices associated with at least one subset of beams in the active candidate beam set.

In some examples, the WTRU may include a measurement or metric associated with a subset of beams in the active candidate beam set. For example, the WTRU may include a blockage prediction associated with one or more beams or subsets of beams that make up the active candidate beam set. The WTRU may determine and report a blockage prediction associated with the active candidate beam set as a whole.

In some examples, the WTRU may include indices associated with one or more subsets of beams or beams in the active candidate beam set that achieve a specific metric. For example, the WTRU may report the indices of beams or subset of beams that have the lowest blockage probability or shortest blockage duration in the active candidate beam set. For example, the WTRU may report indices associated with beams that have the lowest blockage probability or shortest blockage duration in a subset of beam that is in the active candidate beam set.

In some examples, the WTRU may include indices associated with one or more beams or subsets of beams that do not satisfy selection criteria. For example, a subset of beams may be included in an active candidate beam set. The WTRU may report the indices associated with the beams in the subset of beams that do not achieve the required blockage probability or blockage duration thresholds.

In some examples, a WTRU may immediately assume an active candidate beam set is activated upon selection of the active candidate beam set. In some methods, a WTRU may require reception of a confirmation from the base station before assuming that an active candidate beam set is activated.

Procedures for monitoring beams in active candidate beam set are described herein. It may be assumed that a WTRU may monitor at least one beam in an active candidate beam set. Monitoring may include performing one or more measurements on a resource associated with the beam. The resource associated with the beam may be located in the same or different FR as the beam. The WTRU may be triggered to monitor at least one beam in an active candidate beam set. A trigger causing the WTRU to monitor at least one beam in an active candidate beam set may include one or more examples as described in the following paragraphs.

An example of a trigger causing the WTRU to monitor at least one beam in an active candidate beam set may be the detection of beam failure on at least one or all used (or activated) beams.

An example of a trigger causing the WTRU to monitor at least one beam in an active candidate beam set may be the reception of a trigger (e.g., a message, signal, or transmission from the base station).

An example of a trigger causing the WTRU to monitor at least one beam in an active candidate beam set may be a measurement on at least one used (or activated) beam. For example, a WTRU may be triggered to monitor at least one beam in an active candidate beam set when a blockage prediction on at least one used (or activated) beam falls below a threshold.

An example of a trigger causing the WTRU to monitor at least one beam in an active candidate beam set may be a periodic trigger. For example, a WTRU may periodically monitor beams in the active candidate beam set with configurable period and offset.

A WTRU may select a beam in the active candidate beam set on or for which to perform beam failure recovery. The selection of the beam on, or for, which to perform beam failure recovery may be performed based on at least one of several criteria. The criteria may include a measurement such as a highest RSRP (e.g., L1-RSRP) of all the beams in the active candidate beam set; a measurement such as an RSRP (or L1-RSRP) above a threshold; a lowest blockage probability or duration of all the beams in the active candidate beam set; a blockage probability or duration below a threshold; whether monitoring or measurements are performed on resources in the same or different FR; a blockage prediction below or above a threshold; or the confidence value of a blockage prediction.

The selection of the beam on or for which to perform beam failure recovery may be performed based on an identifier associated with the subset of beams that a beam belongs to. For example, a WTRU may select a beam from a selected subset of beams. The selected subset of beams may satisfy at least one criterion. The selected subset of beams may be one from which there are currently no used (or activated) beams. The selected subset of beams may be one from which there is at least one used (or activated) beam. The selected subset of beams may be one to which the beam having suffered beam failure belongs.

If no beam satisfies the above criteria, a WTRU may perform CBRA-BFR. If no beam satisfies the above criteria, a WTRU may be triggered to select a new active candidate beam set.

Examples are described herein of various methods for determining an

$${\overline{q}}_{1}^{Active}$$

set, for example, based on a probability of each beam being the best beam in a future time interval, or a probability of q̅_{1,Si} carrying the best quality beam in a future time interval via beam prediction using FR2 beams.

AI/ML model availability is described herein. In some solutions, a WTRU may be configured to use an AI/ML model to predict the best candidate beam at a future time instance. More generally, the WTRU may use AI/ML model to predict a likelihood of a beam being the best candidate beam in a future time instance. In some cases, the WTRU may be configured to predict the best candidate beam at different levels of granularity.

As stated above, in some solutions, the WTRU may predict the best candidate beam at future time instance. In another solution, the WTRU may predict the best candidate beam set from a plurality of candidate beam sets or partition thereof. In one or more of the solutions described herein, the AI/ML model may be configured at the WTRU by one or more of the following methods: the model may be trained by the WTRU; the model may be trained at the network (e.g., at a base station or another network node) and transferred to the WTRU; the model may be trained at the Operations, Administration, and Maintenance (OAM) and transferred to the WTRU; or the model may be trained at an external server and transferred to the WTRU.

Configuration aspects are described herein. A WTRU may receive one or more parameters from the base station that may be used to perform beam quality predictions. In some solutions, the WTRU may be configured to perform beam quality prediction over a plurality of candidate beam sets. In some cases, such candidate beam sets may be defined based on dynamic partitioning of a total number of available beams. In some solutions, the WTRU may be configured to perform beam quality prediction for a plurality of candidate beams within a preconfigured set of available beams. In some solutions, the WTRU may be configured with a periodicity e.g., T_{BP} of beam prediction. For example, based on this configuration the WTRU may perform inference operation associated with the beam quality prediction at least every T_{BP} time units. In some solutions, the WTRU may be configured to perform beam quality predictions for each candidate beam set every T_{BP} time units. In some solutions, the WTRU may be configured to perform beam quality predictions for each candidate beam every T_{BP} time units. In some solutions, the WTRU may be configured with a beam prediction validity time T_{d}. The WTRU may perform inferences such that the prediction results remain valid at least T_{d} time units. The WTRU may be configured with one or more FR2 beam resource sets (Ψ₂) for performing beam measurements. In some cases, the configuration of the FR2 beam resource set may include a periodicity of RS resources for performing beam measurements. The WTRU may use the measurements from the FR2 beam resource set as an input to the AI/ML model for prediction. In some solutions, the WTRU may determine T_{BP} as a function of periodicity of FR2 beam resource set. In some solutions, the WTRU may derive a value of T_{BP} implicitly as an integer multiple of periodicity of the FR2 beam resource set. In some solutions, the WTRU may derive a value of T_{d} implicitly as an integer multiple of the periodicity of the FR2 beam resource set.

In some solutions, the values of T_{BP} and/or T_{d} may be determined and/or configured as a function of a WTRU's capabilities. The time units T_{BP} and/or T_{d} may be expressed in terms of milliseconds, symbols, slots, subframes, radio frames, or other units.

In some solutions, the WTRU may be configured with parameters that help the WTRU determine the selection of candidate beams or candidate beam sets. For example, the WTRU may be configured to select candidate beams based on a parameter P_{sum-target}. For example, the WTRU may determine the probability of each candidate beam being the best beam at a future time instance. The WTRU may select a candidate beam set if the sum of probabilities of candidate beams within the candidate beam set exceeds the P_{sum-target}. If, for example, no candidate beam set on its own meets this threshold, then the WTRU may select more than one candidate beam set to meet the P_{sum-target} criteria.

In some solutions, the WTRU may be configured with parameters that help the WTRU determine the selection of candidate beam(s). For example, the WTRU may be configured to select candidate beams based on a parameter P_{sum-A}. For example, the WTRU may determine the probability of each candidate beam being the best beam at a future time instance. The WTRU may select a candidate beam such that the probability associated with candidate beam exceeds P_{sum-A}. If no single candidate beam meets this threshold, the WTRU may select two or more candidate beams such that sum of probabilities of candidate beams being the best beams at a future time instance exceeds the P_{sum-A}.

Activation/deactivation of beam quality prediction is described herein. In some solutions, the WTRU may receive an indication from a base station to activate or deactivate beam quality predictions on the candidate beams and/or candidate beam sets. For example, the WTRU may perform beam quality predictions associated with candidate beams until deactivated. In another solution, the WTRU may receive an indication from a base station to activate AI/ML based candidate beam prediction for a configured number of times. In some solutions, the WTRU may perform beam quality predictions when the FR2 beam resource set is configured. For example, the WTRU may deactivate beam quality predictions when the FR2 beam resource set is released. In some solutions, the WTRU may perform blockage prediction of candidate beams until a time duration elapses or until a preconfigured timer expires. In some cases, the WTRU may determine the time duration or the preconfigured timer value implicitly based on a semi-persistent configuration associated with the FR2 beam resource set. In some solutions, the beam quality prediction may be implicitly deactivated by configuring the value of T_{d} to be zero.

Selection of candidate beam subsets is described herein. A WTRU may be configured to select a candidate beam subset q̅_{1,Si} within a plurality of candidate beam sets q̅_{1,Si}, i∈{1,2, . . . , N} based on preconfigured rules/conditions. In some solutions, the WTRU may be configured to select a subset of beam in the q̅₁ based on preconfigured rules/conditions. Possibly such determination may be based on beam quality prediction for a time duration T_{d} in future.

In some solutions, the WTRU may be configured to select a subset of beams q̅_{1,Si} based on criteria determined as a function of likelihood of the beam being the best beam at a future time T_{d}. For example, the WTRU may estimate the probability of each beam in q̅₁ being the best beam out of all the beams. The WTRU may apply an AI/ML model to estimate the probability that the candidate beam is the best candidate beam at a future time. The WTRU may compute the sum of all probabilities associated with the beams within each q̅_{1,Si} (P_{sum_S1},P_{sum_S2}, . . . , P_{sum_SN},). In some solutions, the WTRU may select a subset of beams q̅_{1,Si} corresponding to the highest estimated probability value, P_{sum_Si}, if max{P_{sum_Si}, i∈{1, 2, . . . , N}}≥P_{sum-target} If max{P_{sum_Si}, i∈{1, 2, . . . , N}}<P_{sum-target}, the WTRU may select more than one subset of beams q̅_{1,Si} such that all the beams in the selected subset q̅_{1,Si} collectively satisfy P_{sum-target} with the lowest number of q̅_{1,Si} sets. In some solutions, the WTRU may be configured with a value, Pₘᵢₙ, which corresponds to a minimum probability at which a beam may be considered a candidate beam. When configured with Pₘᵢₙ, the WTRU may select a subset of beams q̅_{1,Si} that contains the highest number of beams whose computed probability is greater than Pₘᵢₙ.

Methods for indicating candidate beam subsets are described herein. In some solutions, the WTRU may be configured to transmit an indication of selected candidate beam subset(s) to a base station. For example, the WTRU may be configuration (e.g., preconfigured) with a mapping between a candidate beam subset q̅_{1,Si} and a set of RACH resources (e.g., preamble, time and/or frequency resources). For example, the WTRU may determine the RACH resource based on the selected candidate beam set and transmit the preamble using the selected RACH resource. In some solutions, the WTRU may be configured to transmit the indication of selected candidate beam set(s) via one or more MAC Control Element (MAC-CE). In some cases, each candidate beam set may be associated with a unique logical identifier. The WTRU may indicate the candidate beam set(s) by transmitting the MAC-CE including the logical identifier(s) associated with the selected candidate beam set(s). The indication may include a bitmap in which each bit position may correspond to a candidate beam set. Upon reception of the indication of selected candidate beam subsets, a base station may update

$${\overline{q}}_{1}^{Active}$$

including only the beam subsets q̅_{1,Si} indicated by the WTRU. The WTRU may receive an acknowledgement from the base station responsive to the candidate beam set indication. The acknowledgement may be a function of the indication method. For example, in case of a RACH-based indication, the WTRU may consider a random-access response (RAR) corresponding to the transmitted preamble as an acknowledgment of its candidate beam set indication. In the case of a MAC-CE based indication, the WTRU may consider a HARQ-ACK corresponding to the transport block that carries the MAC-CE an acknowledgement of candidate beam set indication. Upon receiving a successful acknowledgement, in some cases, the WTRU may consider the indicated beam set to be the active candidate beam set,

$${\overline{q}}_{1}^{Active} .$$

The WTRU may then use

$${\overline{q}}_{1}^{Active}$$

to perform beam failure recovery procedures. For example, upon beam failure detection, the WTRU may use beams of

$${\overline{q}}_{1}^{Active}$$

to perform CFRA-BFR.

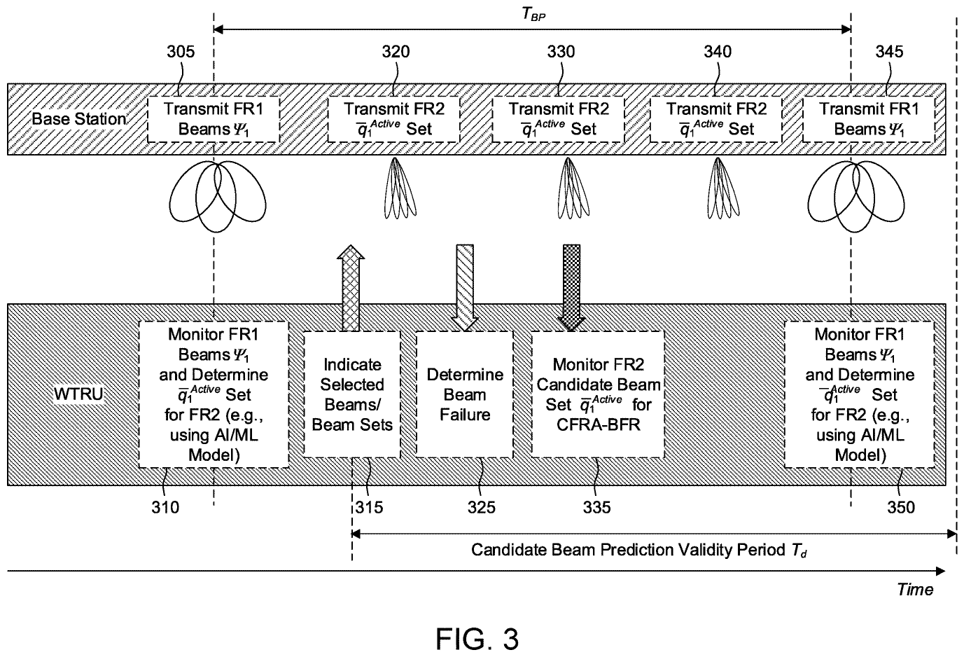

FIG. 3 is a diagram illustrating an example of a beam failure recovery procedure carried out by a base station and WTRU. In the example shown, a WTRU is configured with beam resources in FR1 on which to determine metrics used for the selection of an active candidate beam set in FR2. At 305, the base station transmits using beam resources of FR1, Ψ₁. At 310, the WTRU monitors the configured beam resources W, to determine the active candidate beam set for FR2,

$${\overline{q}}_{1}^{Active} .$$

The WTRU may utilize an AI/ML model to determine the active candidate beam set according to one or more methods describe substantially herein. At 315, the WTRU may send an indication of selected beam resources (e.g., out of beams configured by the parameter candidateBeamRSList) or candidate beam resource subsets to the base station. As shown at 320, 330, and 340, the base station, having a received an indication of the beam(s) selected by the WTRU, transmits in FR2 using the indicated active candidate beam set. At 325, the WTRU, having monitored beam failure detection resources determines that beam failure has occurred. Upon determining beam failure, and given that

$${\overline{q}}_{1}^{Active}$$

is valid within the duration of T_{d}, the WTRU selects a beam in the active candidate beam set and performs CFRA-BFR, as shown at 335. Subsequently at 345, at the end of the period for beam prediction T_{BP}, which may be configured as integer multiple of the periodicity of

$${\overline{q}}_{1}^{Active}$$

the base station again may transmit using the beam resources for FR1, Ψ₁. The WTRU again ma monitor the configured beam resources Ψ₁ to determine the active candidate beam set for FR2,

$${\overline{q}}_{1}^{Active} ,$$

potentially using an AI/ML model as shown at 350.

Procedures for selection of candidate beams are described herein. In a solution, the WTRU may be configured to select a subset of beams in q̅₁ based on rules/conditions, which may be configured, preconfigured, or implicitly derived. Such selection may be based on beam quality predictions for a time duration, T_{d}, in the future. For example, the WTRU may apply an AI/ML model to predict the probability of a candidate beam being the best beam at a future time. For example, the WTRU may rank candidate beams based on their probability of being the best beam for a future time interval. Subsequently, the WTRU may select one or more candidate beams such that a least number of the highest ranked beams out of q̅₁ denoted as set A, satisfies the criteria that the sum of the probabilities (probability that each selected beam being the best beam for a future time interval) of beams in set A, denoted by (P_{sum-A})≥a target on sum probability threshold P_{sum-target}.

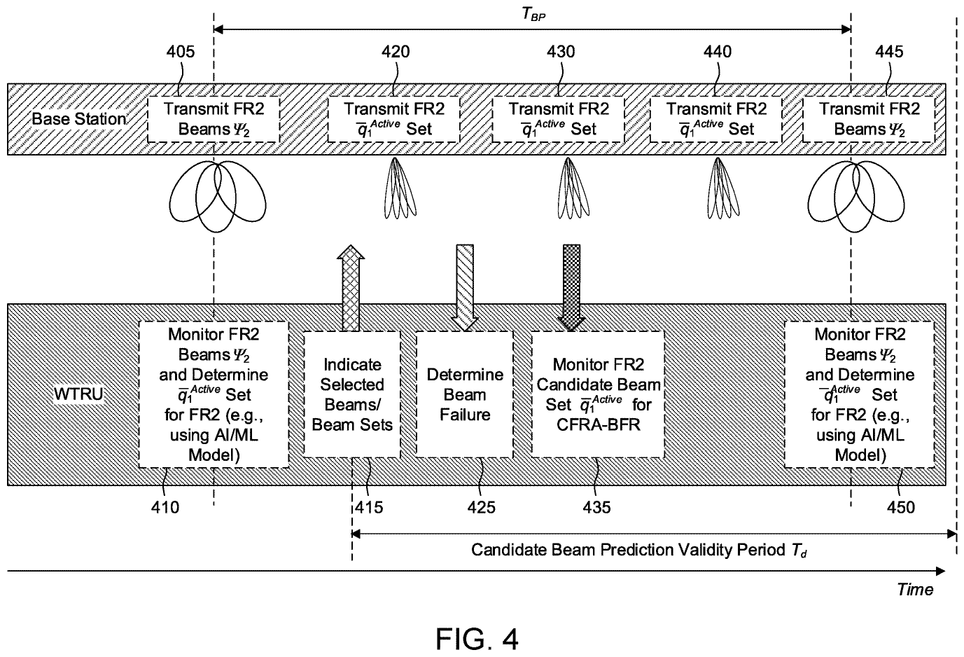

Methods for indicating a candidate beams are described herein. In some solutions, the WTRU may be configured to transmit an indication of selected candidate beam set(s) to the base station. For example, the WTRU may be configured with a mapping between a candidate beam and RACH resources (e.g., preamble, time and/or frequency resources). For example, the WTRU may determine the RACH resource based on the selected candidate beam and transmit the preamble over the selected RACH resource. In some solutions, the WTRU may be configured to transmit an indication of the selected candidate beam via MAC Control Element(s) (MAC-CE(s)). Each candidate beam may be associated with a unique logical identifier. The identifier may be a function of an SSBRI (SS/PBCH Block Resource Indicator) and/or CRI (CSI Reference Signal Resource Indicator). The WTRU may indicate the candidate beam by transmitting the MAC-CE including the logical identifier(s) associated with the selected candidate beam. The indication may include a bitmap wherein each bit position may correspond to a candidate beam set. In some examples, as shown in FIG. 4, upon the reception of the indication, the base station may update

$${\overline{q}}_{1}^{Active}$$

to include only the beam(s) q̅_{1,Si} indicated by the WTRU. For example, the WTRU may receive an acknowledgement from the base station for the candidate beam indication. The acknowledgement may be a function of the indication method. For example, in the case of RACH-based indication, the WTRU may consider a random-access response (RAR) corresponding to the transmitted preamble as an acknowledgment of candidate beam indication. For example, in case of a MAC-CE based indication, the WTRU may consider a HARQ ACK corresponding to the TB (Transport block) carrying the MAC-CE as an acknowledgement of the candidate beam indication. Upon receiving successful acknowledgement, the WTRU may consider the indicated beam(s) to be

$${\overline{q}}_{1}^{Active}$$

set. The WTRU may then apply and use the

$${\overline{q}}_{1}^{Active}$$

set for beam failure recover procedures. For example, upon beam failure detection, the WTRU may monitor beams of the

$${\overline{q}}_{1}^{Active}$$

set to perform CFRA-BFR.

FIG. 4 is a diagram illustrating an example of a beam failure recovery procedure carried out by a base station and a WTRU. In the example shown, the WTRU is configured to make FR2 candidate beam predictions based on characteristics of FR2 beams. As shown in FIG. 4, the base station transmits using beam resources in FR2, denoted by Ψ₂. As shown at 410, the WTRU may monitor the FR2 beam resources Ψ₂ and determine

$${\overline{q}}_{1}^{Active}$$

for FR2 based on a prediction output from AI/ML model. At 415, the WTRU may indicate the selected candidate beams to the base station. The WTRU may use methods described herein for the indication of candidate beam or candidate beam subset(s). As shown at 420, 430, and 440, the base station, having a received an indication of the beam(s) selected by the WTRU, transmits in FR2 using the indicated active candidate beam set. The WTRU may monitor beam resources of

$${\overline{q}}_{1}^{Active}$$

based on a monitoring periodicity, which may be configured by the base station. The monitoring periodicity may be configured as integer multiple of the periodicity of

$${\overline{q}}_{1}^{Active}$$

beams. At 425, the WTRU, having monitored beam failure detection resources, WTRU determines that beam failure has occurred. In some solutions, monitoring active candidate beams

$${\overline{q}}_{1}^{Active}$$

may be triggered by beam failure detection. At 435, the WTRU may monitor a candidate beam set

$${\overline{q}}_{1}^{Active}$$

to perform CFRA-BFR. Subsequently at 445, at the end of the period for beam prediction T_{BP}, which may be configured as integer multiple of the periodicity of

$${\overline{q}}_{1}^{Active}$$

the base station again may transmit using the beam resources for FR2, Ψ₂. The WTRU again may monitor the configured beam resources Ψ₂ to determine the active candidate beam set for FR2,

$${\overline{q}}_{1}^{Active} ,$$

potentially using an AI/ML model as shown at 450.

In some examples, during CFRA, the WTRU may select a beam with a measured quality (e.g., L1-RSRP) that meets a first threshold and predicted blockage probability does not exceed a second threshold as the new candidate beam. The WTRU indicates beam failure and its choice of new beam by transmitting preamble corresponding to the candidate beam. The WTRU may then monitor BFR-PDCCH via BFR-CORESET to confirm the new beam indication. The WTRU may repeat the beam indication procedure using power ramping in the case the WTRU fails to detect BFR-PDCCH from the base station via BFR-CORESET confirming the reception of the new beam indication. If none of the beams in,

$${\overline{q}}_{1}^{Active}$$

satisfies the first threshold, the WTRU may perform CBRA-BFR.

Methods for determining the

$${\overline{q}}_{1}^{Active}$$

set based on predicted metrics of candidate beams such as PMI, CQ and RI, L1-RSRP, SINR, RSRQ using AI/ML are described herein. An AI/ML model may be trained to determine a subset

$${\overline{q}}_{1}^{Active}$$

of active candidate out of beam sets q̅₁ or q̅_{1,Si} based on one or more parameters, including those listed in the following paragraphs. The training (i.e., online or offline training) of the AI/ML model may be performed at the WTRU and/or at the base station and transferred to the WTRU. Other stages of the lifecycle management of the AI/ML model (e.g., model generation, model monitoring, model updating) may also be done at the WTRU and/or at the base station and transferred to the WTRU for deployment.

Parameters that a WTRU receives from a base station and uses to determine candidate beams for q̅₁/q̅_{1,Si} are described herein. A WTRU may receive one or more of the following parameters from the base station (e.g., semi-statically via RRC signaling or dynamically via MAC-CE or DCI, or via other logically equivalent messages or signaling or via other methods) to perform relevant beam predictions for beams of q̅₁ or one or more q̅_{1,Si}.

A WTRU may receive information indicating a time value and/or periodicity (T_{BP}) to be used for performing beam quality measurement(s) (i.e., RI/PMI/CQI/L1-RSRP/SINR/RSRQ, or other metrics) for candidate beams. In some examples, the WTRU may receive a timer value which, when expired, may trigger an assumption that any beam quality measurement made by the WTRU for the candidate beams may no longer be valid, prompting/triggering the WTRU to repeat the measurement. In some examples, the WTRU may be configured with different periodicities for measuring different channel quality parameters. For example, L1-RSRP may need to be measured with a higher periodicity than CQI. In some examples, the WTRU may implicitly determine T_{d} based on knowledge of T_{BP}.

A WTRU may receive information indicating a time duration (T_{d}) that the selected beam quality (PMI, CQI, RI, L1-RSRP, SINR, RSRQ) prediction(s) need to be valid for such that the corresponding beam set/subset q̅_{1,Si} is considered eligible for

$${\overline{q}}_{1}^{Active}$$

set. In some examples, the WTRU may receive information indicating one or more time durations, whereby the measured selected beam quality metric is considered valid. In some examples, the validity duration for one metric may be different from another metric (i.e., a CQI validity duration may be longer than L1-RSRP). In some examples, the WTRU may implicitly determine T_{d} based on knowledge of T_{BP}.

A WTRU may receive one or more target thresholds for channel quality parameters (e.g., PMI, CQI, RI, minimum L1-RSRP, minimum SINR, minimum RSRQ) of the candidate beam(s). In some examples, the WTRU may be preconfigured with target thresholds such that L1-RSRP of the beams in the candidate beam set q̅_{1,Si} may need to exceed the target threshold to be considered eligible for the

$${\overline{q}}_{1}^{Active}$$

set. In some examples, the target thresholds may change as a function of the environment/propagation characteristics. For example, a WTRU may receive a threshold for CQI from the base station in a dense urban environment, which may be different from a CQI threshold for a rural environment.

A WTRU may receive information indicating a number of beams in a candidate beam set q̅_{1,Si} that are expected to meet one or more beam quality parameters in order for q̅_{1,Si} to be considered eligible for

$${\overline{q}}_{1}^{Active}$$

set. In some examples, only one beam in a candidate beam set may need to meet one or more beam quality parameters in order for q̅_{1,Si} to be considered eligible for

$${\overline{q}}_{1}^{Active}$$

set. The WTRU may the use the one beam for beam failure recovery. In some examples, most beams in a candidate beam set (e.g., >90%) may need to have channel quality/quantity measurement values (e.g., L1-RSRP) above a preconfigured target threshold in order for q̅_{1,Si} to be considered eligible for the

$${\overline{q}}_{1}^{Active}$$

set

A WTRU may receive a minimum number of beam quality parameters that must above a preconfigured target threshold in order for q̅_{1,Si} to be considered eligible for the

$${\overline{q}}_{1}^{Active}$$

set. In some examples, only one beam quality parameter (L1-RSRP) may need to be satisfied for the candidate beam set to be considered eligible for the

$${\overline{q}}_{1}^{A c t i v e}$$

set. In some examples, more than one beam quality parameter (e.g., RSRQ in addition to RSRP) may need to be satisfied for the candidate beam set to be considered eligible for the

$${\overline{q}}_{1}^{A c t i v e}$$

set.

A WTRU may receive configuration information indicating an beam resource set (Ψ₂) associated with a particular frequency range (e.g., FR2) for performing beam measurements and for use with AI/ML model to predict candidate beam sets. A beam resource may include CSI-RS or SSB for downlink measurements and/or SRS or TCI state for uplink measurements. A WTRU may implicitly determine T_{BP} and/or T_{d} from the periodicity of a base station providing the beam resource set to the WTRU.

Methods for determining candidate beams for q̅₁/q̅_{1,Si} is described herein. An AI/ML model may be used to determine a subset of q̅_{1,Si} or subset of beams in the set q̅₁ using beam quality predictions for a time duration T_{d} in the future, consistent with one or more of the following solutions. To select one or more q̅_{1,Si}, an AI/ML model may be used to predict one or more of the beam quality parameters (e.g., PMI, CQI, RI, L1-RSRP, SINR, RSQR) for each beam in a candidate set q̅₁ or q̅_{1,Si}. The WTRU may compute the number of beams in each q̅_{1,Si} that satisfy the target beam quality parameter(s). In some examples, such as where a beam quality parameter may be time varying, the WTRU may select the minimum beam quality predicted in the T_{d} interval and report it to the base station. In some examples, the WTRU may select the q̅_{1,Si} with the highest number of beams that satisfy one or more beam quality parameters predicted. In some examples, the WTRU may select q̅_{1,Si} that has the required number of beams satisfying the requirements configured for one or more beam quality parameters. In some examples, the WTRU may indicate the selected q̅_{1,Si} to the base station. For instance, this may be done via a MAC-CE indication as a bit map, PRACH transmission (each q̅_{1,Si} is configured with a unique preamble) or via other methods described substantially herein. Upon the reception of the WTRU's indication, the base station may update

$${\overline{q}}_{1}^{A c t i v e}$$

to include only the q̅_{1,Si} indicated by the WTRU.

The AI/ML model may be used to select a subset of beams out of q̅₁ as follows. The AI/ML model may predict the one or more of the beam quality parameters (PMI, CQI, RI, L1-RSRP, SINR, RSQR) of each beam in q̅₁, which the WTRU may use to determine a subset of candidate beams out of q̅₁. The WTRU may indicate the selected candidate beams (with beam quality parameter exceeding a threshold) to the base station (e.g., via MAC-CE as a bit map). Upon the reception of WTRU's indication, the base station may update

$${\overline{q}}_{1}^{A c t i v e}$$

to only include the subset of beams indicated by the WTRU.

The WTRU may perform CFRA-BFR using

$${\overline{q}}_{1}^{A c t i v e} ,$$

whereby the WTRU may monitor beam resources of

$${\overline{q}}_{1}^{A c t i v e}$$

upon detection of a beam failure.

Methods for assessment of candidate beams for q̅₁/q̅_{1,Si} are described herein. A WTRU may be configured to activate/deactivate AI/ML based on candidate beam prediction and/or (re)assess the validity of the candidate beam set/subset

$${\overline{q}}_{1}^{A c t i v e}$$

output by the AI/ML model based on one or more factors.

Factors for reassessing the validity of the candidate beam set/subset may include a time period. For example, the WTRU may be configured with periodic time instances (e.g., a default periodicity) at which to check the validity of

$${\overline{q}}_{1}^{A c t i v e} .$$

In cases where there may be variations in channel conditions, the periodicity may be increased from the default periodicity. In some examples, a WTRU may be triggered at semi-persistent periodicities to check the validity of

$${\overline{q}}_{1}^{A c t i v e}$$

e.g., reassess the validity every n^{th} subframe unless triggered by an event (e.g., change in channel measurement beyond a threshold).

The factors for reassessing the validity of the candidate beam set/subset may include a change in channel conditions. For example, a change in a channel condition that exceeds a threshold may represent a trigger for the WTRU to reassess the validity of

$${\overline{q}}_{1}^{A c t i v e} .$$

A change in channel condition may refer to a change detected in any one or more of the RSRP, RSRQ, channel coherence time, channel coherence bandwidth, doppler, doppler spread, delay spread, LOS-to-NLOS, NLOS-to-LOS, or other measurements or parameters. For example, a change in L1 measurements (e.g., RSRP, RSRQ, CQI, PMI, RI, LI, SINR) beyond a threshold may trigger the WTRU to reassess the validity of

$${\overline{q}}_{1}^{A c t i v e} .$$

The factors for reassessing the validity of the candidate beam set/subset may include the reception of updated/new thresholds from the base station. For example, the WTRU may be configured to activate/deactivate AI/ML based candidate beam prediction and/or (re)assess the validity of the candidate beam set/subset

$${\overline{q}}_{1}^{A c t i v e}$$

output by the AI/ML model based on reception of updated/new thresholds received from the base station and corresponding to any channel/beam quality measurement, e.g., RSRP, RSRQ, CQI, PMI, RI, LI, SNR, SINR, channel coherence time, channel coherence bandwidth, doppler spread, etc.).

The factors for reassessing the validity of the candidate beam set/subset may include a mobility of the WTRU. A change in base station/TRP, such as a change in the serving base station/TRP may trigger the WTRU to reassess the validity of

$${\overline{q}}_{1}^{A c t i v e} .$$

A change in positioning (e.g., translational, orientational) greater than a threshold may also trigger the WTRU to reassess the validity of

$${\overline{q}}_{1}^{A c t i v e} .$$

The factors for reassessing the validity of the candidate beam set/subset may include the location of the WTRU. Activation of AI/ML-based candidate beam predictions at the WTRU may be based on location. In some solutions, the WTRU may receive an indication from the base station to activate location-based assessments of

$${\overline{q}}_{1}^{A c t i v e} .$$

WTRU also may receive information indicating a set of regions/areas (e.g., in terms of region index/area index) where the model may be valid and a threshold for location estimation accuracy.

The factors for reassessing the validity of the candidate beam set/subset may include an RRC configuration or reconfiguration, such as a change in RRC state (e.g., from Inactive to Connected state); a change in bandwidth part configuration; or a change of beam/beam pair. For example, a change in the best serving beam/beam pair may trigger the WTRU to reassess the validity of the candidate beam set/subset

$${\overline{q}}_{1}^{Active} .$$

The factors for reassessing the validity of the candidate beam set/subset may include detection of beam failure/radio link failure.

The WTRU may be configured to activate/deactivate AI/ML-based candidate beam predictions and/or (re)assess the validity of the candidate beam set/subset

$${\overline{q}}_{1}^{Active}$$

output by the AI/ML model when the WTRU is triggered to transmit SR/BSR, CG transmissions, and/or UL RS (e.g., SRS).

The WTRU may be configured to activate or deactivate AI/ML-based candidate beam predictions and/or (re)assess the validity of the candidate beam set/subset

$${\overline{q}}_{1}^{A c t i v e}$$

output by the AI/ML model when the WTRU determines that the AI/ML model needs refining/retraining. In some examples, the WTRU may determine that the AI/ML model trained to determine a subset

$${\overline{q}}_{1}^{A c t i v e}$$

of active candidate out of beam sets q̅₁ or q̅_{1,Si} is not performing well enough (e.g., performance is not within KPI thresholds sent to the WTRU by the base station).

The WTRU may be configured to activate/deactivate AI/ML-based candidate beam predictions and/or (re)assess the validity of the candidate beam set/subset

$${\overline{q}}_{1}^{A c t i v e}$$

output by the AI/ML model based on reception of an updated/new AI/ML model from base station.

The WTRU may be configured to activate/deactivate AI/ML-based candidate beam predictions and/or (re)assess the validity of the candidate beam set/subset

$${\overline{q}}_{1}^{A c t i v e}$$

output by the AI/ML model based on reception of an explicit request from base station to reassess AI/ML based candidate beam selection.

The WTRU may be configured to activate/deactivate AI/ML-based candidate beam predictions and/or (re)assess the validity of the candidate beam set/subset

$${\overline{q}}_{1}^{A c t i v e}$$

output by the AI/ML model based on reception of additional beam resources/CSI-RS resources from base station.

The WTRU may be configured to activate/deactivate AI/ML-based candidate beam predictions and/or (re)assess the validity of the candidate beam set/subset

$${\overline{q}}_{1}^{A c t i v e}$$

output by the AI/ML model based on rotation of the WTRU.

Methods for AI/ML-assisted location-/time-based

$${\overline{q}}_{1}^{Active}$$

set determination are described herein. Parameters such as position, direction of motion, and speed estimation/reporting may be considered in examples described in the following paragraphs.

The WTRU may receive one or more pilot RSs (e.g., CSI-RS). In some solutions, the WTRU may perform measurements on the RSs (e.g., pathloss, L1-RSRP, doppler frequency, communication delay, LoS probability etc.). Based on the measurements, the WTRU may estimate its position (e.g., relative position from the base station), direction of motion, and/or speed by using an AI/ML model. The WTRU may report its estimated position, direction of motion and/or speed to the base station.

The WTRU may be configured to transmit one or more pilot RSs (e.g., one or more SRSs) to the base station. The base station may perform measurements and estimate the WTRU's position (e.g., relative position), direction of motion, speed and/or its correlation with the positioning information of other WTRUs.

Methods for candidate beam set configuration are described herein. In some solutions, the WTRU may be configured with a candidate beam set q̅₁₋ₜₒₜₐₗ. In some solutions, the WTRU may be configured with sets q̅₁₋ᵤₙᵢₒₙ and q̅_{1-remaining} such that q̅₁₋ₜₒₜₐₗ∩q̅₁₋ᵤₙᵢₒₙ∩q̅_{1-remaining}.

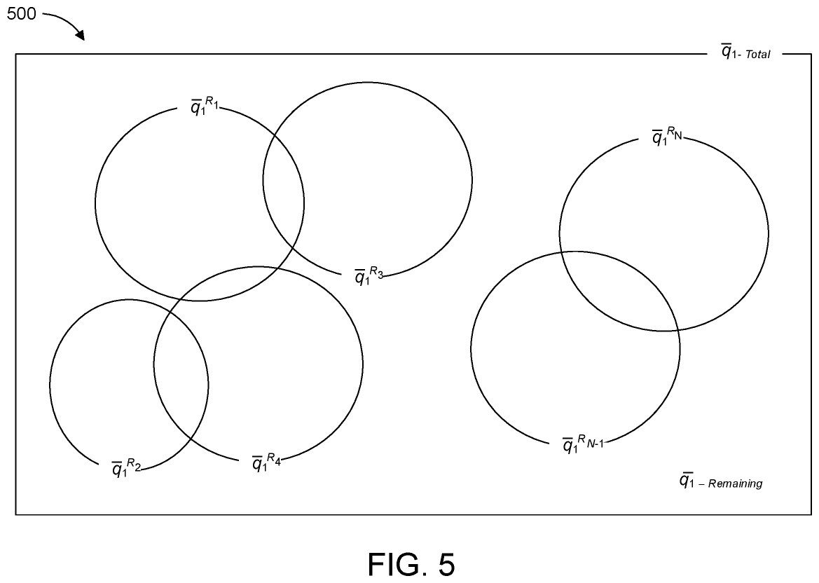

FIG. 5 is a Venn diagram representation of

$${\overline{q}}_{1 - total} , {\overline{q}}_{1}^{{R}_{i}} , i ∈ \{ 1 , 2 , … , N \} , {\overline{q}}_{1 - r emaining} , and {\overline{q}}_{1 - u n i o n} = {⋃}_{i = 1}^{N} {\overline{q}}_{1}^{{R}_{i}} .$$

The candidate beam set q̅₁₋ᵤₙᵢₒₙ may be partitioned/grouped into N subsets with each representing a position region (Rᵢ, i∈{1, 2, . . . , N}) associated with the WTRU. The candidate beam set associated with position region Rᵢ may be represented as

$${\overline{q}}_{1}^{{R}_{i}} .$$

As shown in FIG. 5, the candidate beam set 500 is denoted by q̅₁₋ₜₒₜₐₗ and includes the N partitioned subset

$$( i . e . , {\overline{q}}_{1}^{{R}_{1}} , {\overline{q}}_{1}^{{R}_{2}} , {\overline{q}}_{1}^{{R}_{3}} , {\overline{q}}_{1}^{{R}_{4}} , {\overline{q}}_{1}^{{R}_{N - 1}} , {\overline{q}}_{1}^{{R}_{N}} ) ,$$

and q̅_{1-remaining}.

In some solutions, the WTRU may be configured with a candidate beams set, q̅₁₋ₜₒₜₐₗ, and the partitioned candidate beam sets

$${\overline{q}}_{1}^{{R}_{i}} , i ∈ \{ 1 , 2 , … . , N \} .$$

The WTRU may determine the candidate beam set q̅₁₋ᵤₙᵢₒₙ as the union of all partitioned sets i.e.,

$${\overline{q}}_{1 - u n i o n} = {⋃}_{i = 1}^{N} {\overline{q}}_{1}^{{R}_{i}}$$

where U represents a union of beam sets. The WTRU may determine the q̅_{1-remaining} set by removing all mutual candidate beams of q̅₁₋ᵤₙᵢₒₙ and q̅₁₋ₜₒₜₐₗ from q̅₁₋ₜₒₜₐₗ i.e., q̅_{1-remaining}=complement of beam set q̅₁₋ᵤₙᵢₒₙ.

In some solutions, the WTRU may select one or more of the following as its currently active candidate beam set

$${\overline{q}}_{1}^{A c t i v e} :$$

the candidate beam set q̅₁₋ₜₒₜₐₗ; a position region candidate beam set

$$( e . g . , {\overline{q}}_{1}^{{R}_{1}} , {\overline{q}}_{1}^{{R}_{3}} , etc . ) ;$$

a union of two or more position region candidate beam sets e

$$( e . g . , {\overline{q}}_{1}^{{R}_{1}} ⋃ {\overline{q}}_{1}^{{R}_{3}} , {\overline{q}}_{1}^{{R}_{1}} ⋃ {\overline{q}}_{1}^{{R}_{3}} ⋃ {\overline{q}}_{1}^{{R}_{4}} , etc . ) ;$$

the union of all position region partitioned sets q̅₁₋ᵤₙᵢₒₙ; and/or the q̅_{1-remaining} set.

In some solutions, the WTRU may receive an indication of a

$${\overline{q}}_{1}^{Active}$$

set from a base station based on positioning information reported by the WTRU and/or estimated by the base station. The WTRU may be configured with a starting symbol, slot, or time and application time (e.g., a starting time applied after a time duration from a specific time instance) interval length for the indicated

$${\overline{q}}_{1}^{Active}$$

set. The starting time and time interval length may be, for example, X symbols, slots, or milliseconds (or another time unit) after the

$${\overline{q}}_{1}^{Active}$$

set is indicated to the WTRU.

In some solutions, the WTRU may be configured with or receive an indication of an association between the WTRU's position/location and the candidate beam sets,

$${\overline{q}}_{1}^{{R}_{i}} ,$$

illustrated substantially in FIG. 5. The WTRU may determine its

$${\overline{q}}_{1}^{Active}$$

set based on its positioning information determined (i.e., position, speed direction of motion) and the indicated association between its position and the candidate beam sets

$${\overline{q}}_{1}^{{R}_{i}} .$$

The WTRU may indicate its choice of

$${\overline{q}}_{1}^{Active}$$

by reporting its position information and/or index or indices of the candidate beam subset(s)

$${\overline{q}}_{1}^{{R}_{i}}$$

to the base station (e.g., via MAC-CE, PUCCH, or transmitting a preamble associated with each

$${\overline{q}}_{1}^{{R}_{i}} ) .$$

The WTRU may be configured with the start application time for the

$${\overline{q}}_{1}^{Active}$$

set. For example, X symbols/slots/milliseconds after the WTRU reports its positioning information/new

$${\overline{q}}_{1}^{Active}$$

to the base station. The WTRU may be configured with the value of X by base station via RRC signaling, MAC-CE or DCI. The WTRU may determine the length of application time for the

$${\overline{q}}_{1}^{Active}$$

set based on an accuracy threshold of position estimations (e.g., LoS probability). In some examples, the WTRU may be configured to select a candidate beam set application time t1 for LoS probability p1, and an application time t2 for LoS probability p2 where t1>t2 and p1>p2. The WTRU may determine that a

$${\overline{q}}_{1}^{Active}$$

set may be applicable for a future time interval (e.g., X symbols/slots/milliseconds (or another time unit) in advance) based on the WTRU's estimate of its current/future position.

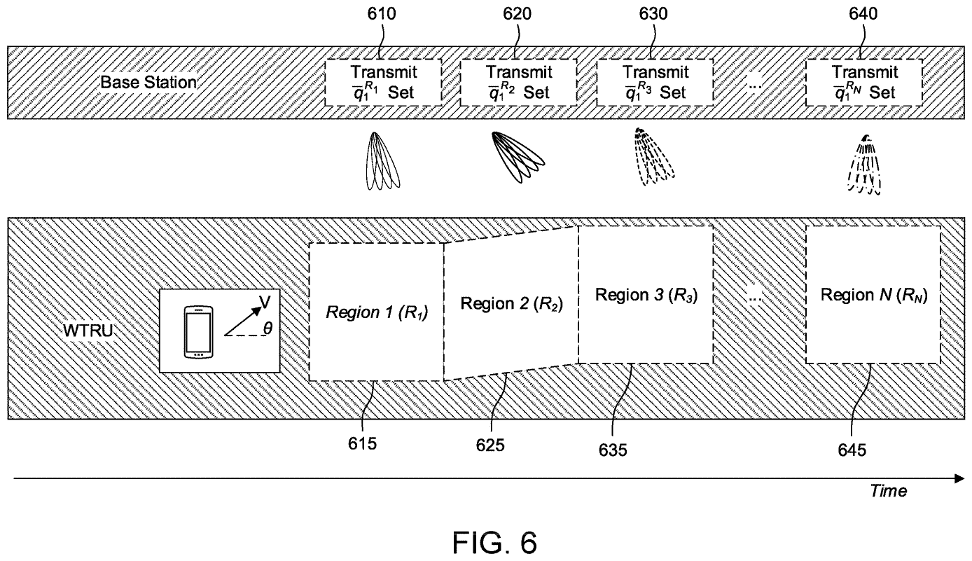

FIG. 6 is a diagram illustrating an example of a CFRA-BFR procedure carried out by a WTRU using location/time-based determinations of

$${\overline{q}}_{1}^{Active} .$$

As shown in FIG. 6, the WTRU may be moving with a given velocity and direction of motion through position regions R₁ to R_{N}. The WTRU may, as shown at 615, 625, 635, and 645, report information to the base station consistent with one or more examples described above that enables the base station to update the active candidate beam set based on the position of the WTRU (or the predicted position of the WTRU in future time intervals). For example, the WTRU may indicate its position within each region to the base station, and/or send an indication to the base station of a selected candidate beam set

$${\overline{q}}_{1}^{{R}_{i}}$$

associated with the region in which the WTRU is positioned or is predicted to be positioned in the future. The base station may update the active candidate beams set, as shown at 610, 620, 630, and 640, to use beams associated with specific position regions,

$${\overline{q}}_{1}^{{R}_{1}} , {\overline{q}}_{1}^{{R}_{2}} , {\overline{q}}_{1}^{{R}_{3}} , ... {\overline{q}}_{1}^{{R}_{N}} .$$

Default WTRU behaviors and activation/deactivation procedures for AI/ML assisted candidate beam determinations are described herein. In some solutions, the WTRU may receive a dynamic indication (e.g., MAC-CE and/or DCI based-indication, or other logical equivalents) to activate/de-activate positioning-based candidate beam set determination. The WTRU may receive a deactivation indication when a fallback procedure is triggered. For example, one such instance may occur when an accuracy of position measurements (e.g., LoS probability reported/determined by the base station) falls below a threshold. After receiving the activation indication, by default, the WTRU may be configured to select q̅₁₋ₜₒₜₐₗ or a subset of q̅₁₋ₜₒₜₐₗ (e.g., q̅₁₋ᵤₙᵢₒₙ) as its

$${\overline{q}}_{1}^{Active}$$

set. Besides the activation indication, the WTRU may also be indicated an initial

$${\overline{q}}_{1}^{Active}$$

set. In some solutions, the WTRU may determine the

$${\overline{q}}_{1}^{Active}$$

set after receiving activation for position-based candidate beam determination. The WTRU may perform BFR using the indicated/determined

$${\overline{q}}_{1}^{Active}$$

using a “position-based BFR procedure”. The WTRU may also receive an indication of an activation time interval, e.g., via a parameter such as positioning-bfr-time. The WTRU may disable position-based candidate beam determination when an amount of elapsed time since activation becomes equal to the activation time interval, e.g., as defined by positioning-bfr-time.

Fallback procedure triggers are described herein. The WTRU may follow a “fallback procedure for position-based candidate beam determination” based on one or more triggers. The triggers may be based on the accuracy of location estimates. One such trigger may be fulfilled when the accuracy of location estimates falls below a predefined threshold. For example, the WTRU may switch to a fallback procedure if the LoS probability is less than a threshold p_fallback. The WTRU may follow a fallback procedure for selecting candidate beam set X symbols/slots/milliseconds after reporting LoS probability to the base station. WTRU may be configured with X by a base station via RRC signaling, MAC-CE, DCI, or other logically equivalent signaling.

The fallback procedure may be triggered when a quality (e.g., L1-RSRP) of all beams in the currently active candidate beam set,

$${\overline{q}}_{1}^{Active} ,$$

are determined to be lower than a threshold based on beam quality measurements performed by the WTRU.

The fallback procedure may be triggered when the measurement quality of positioning-related signal (e.g., GNSS, PRS) falls below a predefined threshold.

The fallback procedure may be triggered when the WTRU's current position as estimated by the WTRU conflicts with the base station's indicated

$${\overline{q}}_{1}^{Active}$$

set. The WTRU may send an indication (e.g., a one-bit indication) to the base station to request a new

$${\overline{q}}_{1}^{Active}$$

set and/or a new association between WTRU's position and position region sets

$${\overline{q}}_{1}^{{R}_{i}} .$$

The fallback procedure may be triggered when the WTRU's current position estimated by the base station conflicts with the WTRU-determined

$${\overline{q}}_{1}^{Active}$$

set. The WTRU may receive an indication (e.g., a one-bit indication) from the base station followed by an indication of a new

$${\overline{q}}_{1}^{Active}$$

and/or a new association between WTRU's position and position region sets

$${\overline{q}}_{1}^{{R}_{i}} .$$

The fallback procedure may be triggered when the WTRU's current position falls outside all the position region sets or q̅₁₋ᵤₙᵢₒₙ set. If such condition is determined by base station, the WTRU may, for example: receive an indication (e.g., a one-bit indication) from the base station followed by an indication of a new

$${\overline{q}}_{1}^{Active}$$

and/or a new association between WTRU's position and position region sets

$${\overline{q}}_{1}^{{R}_{i}} ;$$

or receive a de-activation indication for positioning-based candidate beam determination.

If determined by the WTRU, the WTRU may send a an indication (e.g., a one-bit indication) to the base station to request a new

$${\overline{q}}_{1}^{Active}$$

set and/or a new association between a WTRU's position and position region sets

$${\overline{q}}_{1}^{{R}_{i}} .$$

The WTRU may receive an explicit indication to follow fallback procedure through RRC/MAC-CE/DCI based indication.

Fallback procedures for position-based candidate beam determination are described herein. In some solutions, the WTRU may enlarge its currently active candidate beam set in one or more ways. The WTRU may include candidate beams from other position region sets to its

$${\overline{q}}_{1}^{Active}$$

set (e.g. if the fallback procedure is triggered due to loss of location estimation accuracy). In some examples, the WTRU may include candidate beams from neighboring position region sets. For example, if the current

$${\overline{q}}_{1}^{Active} = {\overline{q}}_{1}^{{R}_{3}} ,$$

then the WTRU may select a new

$${\overline{q}}_{1}^{Active} = {\overline{q}}_{1}^{{R}_{2}} ⋃ {\overline{q}}_{1}^{{R}_{3}} ⋃ {\overline{q}}_{1}^{{R}_{4}} .$$

In some solutions, the WTRU may select q̅₁₋ᵤₙᵢₒₙ as its

$${\overline{q}}_{1}^{Active}$$

set.

In some solutions, the WTRU may add one or more beams having QCL-TypeD with PDCCH DMRS from the current MAC-CE indicated TCI-state set.

In some solutions, the WTRU may receive an indication to switch to a default

$${\overline{q}}_{1}^{Active}$$

set based on the determination of events greater than more than a number of times preconfigured by the base station. This may occur when a CFRA-BFR attempt fails to find a new candidate beam with positioning-based

$${\overline{q}}_{1}^{Active}$$

set leading to CBRA-BFR. However, the new beam determined through CBRA-BFR (q_{new-CBRA-BFR}) may have the same spatial Tx/Rx parameter (QCL Type-D) with a beam in the default

$${\overline{q}}_{1}^{Active} set .$$

In some solutions, the WTRU may receive an indication or request to switch off or disable positioning-based candidate beam determination based on at least one of the following conditions. A condition may be that the accuracy of a positioning estimate remains below a threshold for a preconfigured time interval. For example, this may be when a LoS probability remains below a threshold p_switchoff for a preconfigured time interval position_bfr_los_max_time. A condition resulting in the disabling of positioning-based candidate beam determination may be met if CFRA-BFR with using

$${\overline{q}}_{1}^{Active}$$

determined using positioning-based methods a number of times that exceeds a exceeds a preconfigured threshold bfr_fail_max_count. For example, the condition may be met if, within a time window defined by a parameter such as time_window_bfr_fail, CFRA-BFR fails a number of times that exceeds the threshold.

Position-based BFR procedures are described herein. A WTRU may perform BFR (e.g., CFRA-BFR) using

$${\overline{q}}_{1}^{Active}$$

and determine BFR related parameters using one or a combination of the following steps. For example, the WTRU may monitor the beam quality of

$${\overline{q}}_{1}^{Active}$$

candidate bam resources (e.g., L1-RSRP). The WTRU may initiate monitoring candidate beams upon the detection of a beam failure or one or more beam failure instances. Alternatively, or additionally, the WTRU may monitor candidate beams periodically, where the periodicity is configured by the base station. For example, monitoring periodicity=a×periodicity of

$${\overline{q}}_{1}^{Active}$$

beams and a is dynamically indicated via MAC-CE or DCI. Default value of a (e.g., a=1) is RRC configured. In some solutions, the WTRU may determine α based on position information. For example, the WTRU may determine α based on LoS probability. For example, the WTRU may set α=α₁ for a LoS probability p₁ and set α=α₂ for LoS probability p₂, where α₁>α₂ and P₂>P₁.

The WTRU may select a beam with a measurement beam quality (e.g., L1-RSRP) as the new candidate beam and indicate the selected beam to the base station. For example, the WTRU may select a beam corresponding to the highest measured L1-RSRP.

In some solutions, the WTRU may monitor candidate beams upon fulfillment of at least one of the following conditions: when the WTRU's direction of motion changes; when a LoS probability of the current beam falls below a threshold (e.g., configured by the base station); when a difference between a WTRU's current position and previously reported position exceeds a position/distance threshold; or, when the speed of the WTRU exceeds a threshold.

The WTRU may indicate beam failure and its choice of new beam by transmitting a preamble corresponding to a beam selected from

$${\overline{q}}_{1}^{Active} .$$

The WTRU may monitor a BFR-CORESET for confirmation from the base station. In this case, the WTRU may receive confirmation (e.g., by receiving a PDCCH transmission) from the base station using the new beam and terminate the BFR process.

In cases where the WTRU does not receive a confirmation of its beam selection within a monitoring window duration (which may be determined using the procedures described substantially here), the WTRU may attempt to retransmit the preamble after increasing its transmit power. The WTRU may determine the increase of transmit power based on BFR-related parameter determination procedures described substantially herein. In cases where a configured number of failed attempts is meets or exceeds a threshold and/or the WTRU cannot successfully recover by using the BFR procedure before timer expiration (e.g., no new beam selection is made, or no confirmation from the base station is received, etc.), the WTRU may perform CBRA-BFR. For example, if the WTRU determines that none of the measurements of beams in

$${\overline{q}}_{1}^{A c t i v e}$$

satisfy abeam quality threshold (e.g., before timer expiration), the WTRU may perform CBRA-BFR.

Methods for AI/ML-assisted q_{new} set determination for SCell BFR are described herein. A WTRU may initiate beam failure recovery based on a random-access procedure. In some examples, the WTRU may configure or be configured with the random-access parameters, a start time duration set forth by the parameter BFR_Timer, and may apply power ramping parameters. The WTRU may monitor and measure one or more of the reference signals based on resources specified, for example, by parameters such as candidateBeamRSList or candidateBeamRSSCellList. For example, the WTRU may determine if at least one of the SSBs has an SS-RSRP above a respective RSRP_Threshold amongst the SSBs in candidateBeamRSList or candidateBeamRSSCellList, or at least one of the CSI-RSs has CSI-RSRP above respective RSRP_Threshold amongst the CSI-RSs in candidateBeamRSList or candidateBeamRSSCellList. The WTRU may then select the respective reference signal as the candidate new beam/random-access resource for BFR procedure. For example, the term q_new may be used to present the new selected beam/random-access resource. The WTRU may send a PRACH transmission using respective random-access resources and according to spatial relationships with the periodic CSI-RS resource configuration or with SS/PBCH block associated or QCL-ed with a beam specified by the index q_new.

Alternatively, or additionally, if uplink channel resources (e.g., uplink shared channel resources (UL-SCH)) are available, a WTRU may initiate a MAC-CE beam failure recovery procedure. As such, the WTRU may generate the BFR MAC-CE and transmit on the respective uplink channel resources.

A WTRU may determine, identify, or be configured with one or more CORESETs for use in a random-access procedure as may be performed during beam failure recovery. In some examples, the WTRU may monitor for PDCCH transmissions in a search space set to detection a DCI format with a respective CRC scrambled with a Radio Network Identifier (e.g., C-RNTI or MCS-C-RNTI). The WTRU may determine the same antenna port quasi-collocation parameters as those associated with the index q_new for monitoring the PDCCH in a search space set and receiving a corresponding PDSCH.

If a time duration specified by the parameter BFR_Timer has expired, and if a beam failure recovery procedure has not been accomplished successfully, the WTRU may trigger a link failure detection and follow with link failure recovery (LFR) procedures.

A problem addressed by one or more embodiments described herein may be whether or how to determine a set of (available) q_new for SCell BFR.

Some solutions may involve the prediction of beam availability based on an AI/ML model. In some solutions, a WTRU may be configured or receive one or more thresholds for one or more measurement parameters (e.g., L1-RSRP), wherein the WTRU may use the thresholds for determining/predicting beam availability (e.g., via AI/ML models). The thresholds may be provided for one or more measured parameters (e.g., rsrp-ThresholdBFR-AIML), or the average of the measured parameters over a time duration over a set of measurements (e.g., rsrp-ThresholdBFR-AIML-Avg). The WTRU may explicitly be provided with one or more thresholds (e.g., via RRC signaling or other logically equivalent signaling). Alternatively, or additionally, the WTRU may implicitly determine one or more thresholds based on a provided value on the difference/delta/offset between the measured parameters and/or the measured average values (e.g., between rsrp-ThresholdBFR-AIM/rsrp-ThresholdBFR-AIML-Avg and rsrp-ThresholdBFR).

In some solutions, a WTRU may determine/predict (e.g., using an AI/ML model) one or more measurements or parameters (e.g., L1-RSRP) for one or more beams in a list (for beam failure recovery) in one or more time-instances. The list may be provided by a parameter such as candidateBeamRSSCellList. For example, at time instance to, the WTRU may determine/predict L1-RSRP for one or more candidate beams in a future time instance t=T (e.g., T=a×periodicity of beams in candidateBeamRSSCellList. In some embodiments, the WTRU may determine/predict (e.g., using an AI/ML model) an average of one or more parameters (e.g., an average L1-RSRP) for one or more beams in a list (e.g., a list of beams provided for beam failure recovery) in one or more time intervals. For example, at time t₀, the WTRU may determine/predict an average L1-RSRP for one or more candidate beams (e.g., candidateBeamRSSCellList) in a future time interval (e.g., t₁≤t≤t₂, where t₀≤t₁<t₂).

In some solutions, a WTRU may determine/predict one or more new selected beams (e.g., q_new). In the event the WTRU is not configured to utilize AI/ML models, the WTRU may use legacy procedures for selection of q_new that may be based on one or more measurements or parameters (e.g., L1-RSRP). Alternatively, the WTRU may determine that the use of an AI/ML model for beam availability prediction is enabled (e.g., based on configuration information or a flag indication). As such, the WTRU may determine/predict the selected new beam based on a list of candidate beams (e.g., candidateBeamRSSCellList). In selecting/predicting the q_new, one or more of the following determinations may be made. For example, the WTRU may determine that one or more measured parameters for the selected/candidate beam are higher than respective threshold (e.g., instantaneous L1-RSRP measurements≥rsrp-ThresholdBFR). In some examples the WTRU may determine that one or more predicted parameters (e.g., at time t=T) for the selected/candidate beam are higher than respective thresholds (e.g., rsrp-ThresholdBFR-AIML). In some examples, the WTRU may determine that one or more predicted average parameters (e.g., at time t=t₀ for a future time interval) for the selected/candidate beam are higher than respective thresholds (e.g., rsrp-ThresholdBFR-AIMLAvg).

Methods for activation/deactivation of the use of an AI/ML model in beam availability prediction are described herein. In some solutions, a WTRU may determine if the use of an AI/ML model in beam availability prediction is enabled/disabled (activated/deactivated) based on one or more implicit indications. In some examples, the WTRU may determine that the AI/ML model is activated/enabled, such as when the WTRU is configured/provided with one or more parameters (e.g., rsrp-ThresholdBFR-AIML and/or rsrp-ThresholdBFR-AIML-Avg).

In some solutions, a WTRU may be provided with an indication (e.g., a one-bit flag) for enabling/disabling (or activating/deactivating) the use of the AI/ML model in beam availability predictions. The WTRU may use the flag indication to determine whether use of the AI/ML model is enabled/disabled. Alternatively, or additionally, the WTRU may be configured to use the AI/ML model based on one or more of the following determinations. For example, the WTRU may determine that a MAC-CE transmission indicating selected beams q_new may be subject to length/size restrictions. In other words, after removing beams that are predicted to be unavailable by AI/ML, the remaining beams from which the WTRU may select q_new for initiating a MAC-CE beam failure recovery procedure may only allow for bit maps of limited size (e.g., one octet bit map). In that case, the WTRU may determine to use the AI/ML model for beam availability predictions. The WTRU may indicate the use of an AI/ML model as part of the MAC-CE message.

In some examples, the WTRU may determine that after removing the beams that are predicted to be unavailable by AI/ML from the list of candidate beams, there may be no remaining candidate beams from which to select q_new for initiating a MAC-CE beam failure recovery procedure. In other words, the WTRU may determine that none of the beams in the list of candidate beams may satisfy both the thresholds set forth by the parameters rsrp-ThresholdBFR and rsrp-ThresholdBFR-AIML. In this case, the WTRU may determine to use the AI/ML model for beam availability predictions.

The accuracy of an AI/ML model in beam availability prediction is described herein. In some solutions, a WTRU may determine the accuracy of the AI/ML model, where the WTRU may indicate/report the accuracy parameters to base station and suggest/request/indicate to activate/deactivate the AI/ML model. In some examples, the WTRU may be configured or provided with one or more parameters for determining the accuracy of the AI/ML model (e.g., confidence level parameters).

For example, the WTRU may be configured/provided with a parameter that indicates a maximum difference (e.g., delta_max_RSRP) that is permitted between a predicted parameter (e.g., L1-RSRP for a future time instance t=T) and an actual measured value (e.g., in actual future time instance t=T). In some examples, the WTRU may be configured/provided with a parameter that indicates a maximum difference (e.g., delta_max_RSRPAvg) that is permitted between a predicted average of a parameter (e.g., average of L1-RSRP for a future time instance t=T) and an actual measured average value (e.g., in actual future time instance t=T).

The WTRU may determine if the difference between the predicted parameters or average of parameters and the actual values for one or more of the (selected) beams in the list of candidate beams exceeds the configured maximum allowed difference. In an example, the WTRU may compute the difference between the measured L1-RSRP/average of measured L1-RSRP and predicted L1-RSRP/predicted average L1-RSRP for one or more of the candidate beams. The WTRU may determine if the number of beams that fail to stay within the maximum difference thresholds (e.g., delta_max_RSRP/delta_max_RSRPAvg) between measured and predicted L1-RSRP/predicted average L1-RSRP exceed a configured number. If the number of beams exceeds the configured number, the WTRU may perform one or more of the following steps. The WTRU may send an indication (e.g., to a base station) indicating that the accuracy of the AI/ML model for beam availability prediction is not acceptable (e.g., if the estimated accuracy has fallen below a threshold). The WTRU may indicate the AI/ML model accuracy, for example, using an indicator such as a one-bit flag. In some cases, the WTRU may suggest/request/report to base station to recalibrate or update the AI/ML model and/or transfer further information on the AI/ML model to the WTRU.

AI/ML assisted BFD-RSs and configuration determination are described herein. In some solutions, a WTRU may recommend one or more BFD-RSs for BFR operation. For example, the WTRU may be semi-statically configured with a set of RSs for BFD (e.g., 64 beams). The WTRU may dynamically indicate the availability of each RS for BFD (e.g., bit map) or a set of RSs (e.g., set index).

In some solutions, the WTRU may monitor the recommended RSs (or RS sets) for BFD (BFD-RSs set go is defined by both semi-static configuration and dynamic indication) after receiving base station confirmation (e.g., receiving one or more of PDCCH, DCI and MAC-CE).

In some solutions, the WTRU may monitor default BFD-RSs before recommending BFD-RSs and/or receiving the confirmation from the base station. For example, the WTRU may determine the N first or last configured BFD-RSs among the configured BFD-RSs. In some examples, the WTRU may use RSs for QCL-Type D for PDCCHs/CORESETs/Search Spaces. The WTRU may monitor the recommended BFD-RSs after recommending BFD-RSs and/or receiving the confirmation from the base station.

In some solutions, the WTRU may indicate other related information in addition to the recommended BFD-RSs. For example, the WTRU may indicate a monitoring periodicity and/or RS periodicity of BFD-RSs.

The WTRU may indicate a detection quality threshold (e.g., for detecting beam failure instance). For example, the WTRU may indicate one or more qualities for beam failure detection (e.g., hypothetical PDCCH BLER and/or L1-RSRP).

The WTRU may indicate a detection counter threshold (e.g., for detecting beam failure instance). For example, the WTRU may indicate a number for beam failure detection (e.g., 3)

The WTRU may indicate a detection timer threshold. For example, the WTRU may indicate a value for timer expiration for BFD.

The WTRU may indicate a time offset and/or duration for BFD-RS activation/deactivation. For example, the WTRU may indicate a time instance (e.g., 4 slots from the WTRU indication) and/or time duration (e.g., for activation during 30 slots) for BFD-RS activation/deactivation.

Indication by a base station of BFD-RSs may be accompanied by various information. For instance, a base station may dynamically indicate (e.g., via one or more of DCI, MAC-CE or RRC) one or more BFD-RSs with a monitoring periodicity. For example, the base station may dynamically indicate the monitoring periodicity of BFD-RSs. The WTRU may adaptively select a BFD-RS monitoring periodicity based on the base station indication. If no signaling is received, the WTRU may monitor BFD-RSs based on the periodicity of BFD-RSs. When indicated by the base station, the WTRU may monitor BFD-RSs with different periodicity than the periodicity of BFD-RSs. This may be, for example, a 1 bit indication to double the periodicity when beam failures are less frequent (new periodicity=2×periodicity of BFD-RSs).

The base station may indicate a detection quality threshold (e.g., for detecting beam failure instance). For example, the base station may indicate one or more qualities for beam failure detection (e.g., hypothetical PDCCH BLER and/or L1-RSRP).

The base station may indicate a detection counter threshold (e.g., for detecting beam failure instance). For example, the WTRU may indicate a number for beam failure detection (e.g., 3).

The base station may indicate a detection timer threshold. For example, the WTRU may indicate a value for timer expiration for BFD.

The base station may indicate a time offset and/or duration for BFD-RS activation/deactivation. For example, the WTRU may indicate a time instance (e.g., 4 slots from the WTRU indication) and/or time duration (e.g., for activation during 30 slots) for BFD-RS activation/deactivation.

Location based BFD-RS and/or BFD parameter prediction is described herein. In some solutions, a WTRU may activate/deactivate BFD-RSs and/or associated BFD parameters (e.g., one or more of monitoring periodicity, detection quality threshold, detection counter threshold, detection timer threshold and time offset and/or duration for BFD-RS activation/deactivation) based on one or more of WTRU position, WTRU speed, WTRU direction of movement and correlation with the movement of other WTRUs in a WTRU's vicinity.

For example, the WTRU may be configured with one or more IDs (e.g., zone IDs, direction IDs, speed IDs and etc.,) and each ID may be associated with one or more BFD-RSs and/or associated BFD parameters. The WTRU may activate and deactivate one or more BFD-RSs and/or associated BFD parameters based on the one or more parameters.

One such parameter may be a WTRU position. In some solutions, the WTRU may identify an ID (e.g., zone ID) associated with WTRU position. Based on the identified ID, the WTRU may activate associated BFD-RSs and/or BFD parameters with the identified ID.

Another such parameter may be a WTRU direction. In some solutions, the WTRU may identify an ID (e.g., direction ID) associated with WTRU moving direction. Based on the identified ID, the WTRU may activate associated BFD-RSs and/or BFD parameters with the identified ID.

Another such parameter may be a WTRU speed. In some solutions, the WTRU may identify an ID (e.g., speed ID) associated with WTRU moving direction. For example, the WTRU may be configured with two thresholds (e.g., a first threshold and a second threshold (the first threshold<the second threshold)). The WTRU may determine a first ID if WTRU speed is lower than the first threshold. If the WTRU speed is higher than the first threshold and lower than (or equal to) the second threshold, the WTRU may determine the second threshold. If the WTRU speed is higher than the second threshold, the WTRU may determine the third threshold. Based on the identified ID, the WTRU may activate associated BFD-RSs and/or BFD parameters with the identified ID.

Described herein are embodiments further describing the solutions presented in paragraphs above. Some embodiments described herein concern FR2 candidate beam set determination through FR1 beam quality measurements and an AI/ML model.

In some embodiments, a WTRU may receive information indicating an association between a set of beams Ψᵢ(e.g., FR1 beams) and each candidate beam subset q̅_{1,Si} Alternatively, or additionally, the WTRU may receive an indication of the association between each beam of Ψ₁ and each candidate beam of q̅₁. The WTRU may receive parameters for using an AI/ML model trained by the base station or another network node, or the WTRU may train an AI/ML model for candidate beam prediction. The WTRU may receive an indication from a base station/WTRU and determine to activate AI/ML-based blockage predictions and candidate beam set determination.

The WTRU may perform beam measurements of Ψ₁ (e.g., L1-RSRP), and an AI/ML model may be used to predict the blockage probability of each q̅_{1,Si} (P_{blockage-S1}, P_{blockage-S2}, . . . , P_{blockage-SN}) or each candidate beam (P_{blockage-1}, P_{blockage-2}, . . . , P_{blockage-M}). The WTRU may indicate indices and/or a predicted blockage probability of all or selected set of q̅_{1,Si} to the base station. WTRU may receive configuration information for a new

$${\overline{q}}_{1}^{A c t i v e}$$

from the base station. For example, the WTRU may indicate: indices and blockage probabilities of a preconfigured number of q̅_{1,Si} that have the lowest/highest blockage probability; indices of q̅_{1,Si} that have lower/higher blockage probability than a preconfigured threshold; or indices of q̅_{1,Si} that contains more than a configured number of candidate beams with lower/higher blockage probability than a configured blockage probability threshold.

The WTRU may update

$${\overline{q}}_{1}^{A c t i v e}$$

based on blockage probability predictions on q̅_{1,Si} and indicate the selected set of q̅_{1,Si} to the bae station (e.g., via MAC-CE/PUCCH/transmitting preamble associated with each q̅_{1,Si}).

The WTRU may indicate indices and/or predicted blockage probability of all or selected set of individual candidate beams in

$${\overline{q}}_{1} , i . e . , . , {\overline{q}}_{1}^{( j )}$$

to the base station. WTRU may receive configuration information for a new

$${\overline{q}}_{1}^{Active}$$

from the base station. For example, the WTRU may indicate: indices and blockage probabilities of a preconfigured number of

$${\overline{q}}_{1}^{( j )}$$

that have the lowest/highest blockage probability or indices of

$${\overline{q}}_{1}^{( j )}$$

that have lower/higher blockage probability than a preconfigured threshold. The WTRU may update

$${\overline{q}}_{1}^{Active}$$

based on blockage probability predictions on individual beams in

$${\overline{q}}_{1} , i . e . , . , {\overline{q}}_{1}^{( j )} ,$$

and indicate the selected set of

$${\overline{q}}_{1}^{( j )}$$

to the base station (e.g., via MAC-CE/PUCCH or other logically equivalent signaling).

The WTRU may indicate a set of

$${\overline{q}}_{1 , S i} / {\overline{q}}_{1}^{( j )}$$

and their associated blockage probabilities to the base station or WT RU selecting a new

$${\overline{q}}_{1}^{Active}$$

can be based on outcome of the blockage predictions. For example, the WTRU may indicate a number of

$${\overline{q}}_{1 , Si} / {\overline{q}}_{1}^{( j )}$$

greater than a configured number in the current

$${\overline{q}}_{1}^{A c t i v e}$$

predicted to have higher blockage probability than a threshold blockage probability based on a new blockage prediction. Based on AI/ML model predictions, the WTRU may determine that the number of

$${\overline{q}}_{1 , S i} / {\overline{q}}_{1}^{( j )}$$

in the current

$${\overline{q}}_{1}^{Active}$$

with higher blockage probability than a preconfigured threshold exceeds a configured number

The WTRU may monitor

$${\overline{q}}_{1}^{Active}$$

periodically or upon the detection of a beam failure and to determine a new beam. The WTRU may perform BFR (e.g., CFRA-BFR) based on beam measurements and/or blockage probability predictions on beams in

$${\overline{q}}_{1}^{Active} .$$

The TRU may monitor a quality (e.g., L1-RSRP) of beams in

$${\overline{q}}_{1}^{Active}$$

set periodically or upon the detection of a beam failure/one or more beam failure instances for selecting a new beam. The WTRU may select a new beam based on beam measurements (e.g., beam with highest L1-RSRP or beam with L1-RSRP exceeding a threshold) and predicted blockage probability (e.g., beam in

$${\overline{q}}_{1}^{Active}$$

with the lowest blockage probability or a beam with blockage probability lower than a threshold) if at least one beam satisfies required beam quality measurements and/or blockage probability predictions. The WTRU may indicate beam failure and choice of new beam by transmitting a preamble corresponding to the new beam and WTRU may monitor resources provided via the parameter BFR-CORESET for confirmation from the base station. WTRU may repeat preamble transmission process with increase transmit power if a confirmation of selection new beam is not received from the base station. If none of the beams in

$${\overline{q}}_{1}^{Active}$$

satisfy required beam quality measurements and/or blockage probability predictions and/or the WTRU fails to receive a new beam selection confirmation from the base station, the WTRU may perform CBRA-BFR.

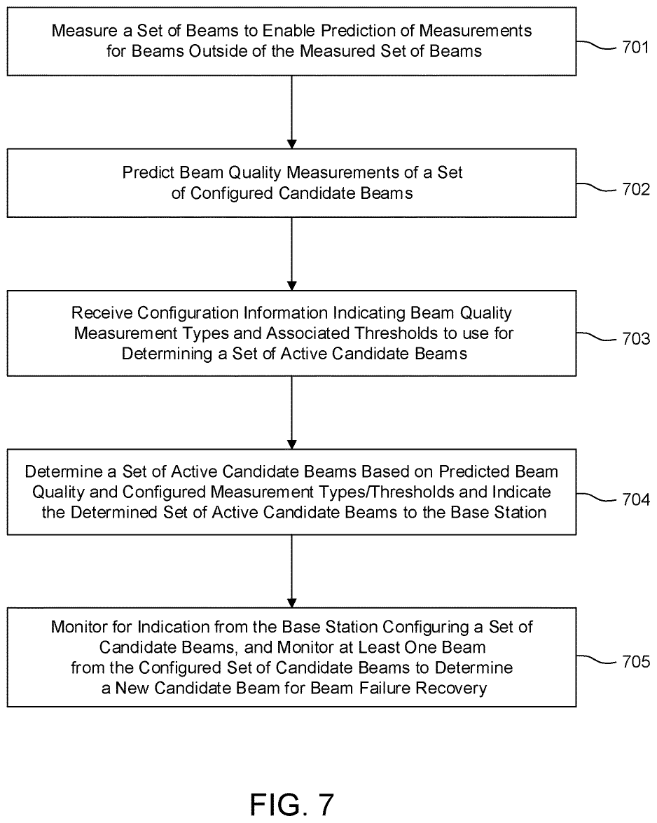

FIG. 7 is a flowchart illustrating steps as may be performed by a WTRU for candidate beam set determination based on configured beam quality measurements and thresholds with the support of AI/ML beam predictions. As shown at 701, the WTRU measures a set of beams (Ψ₁) to enable prediction of measurements for beams outside of the set of measured beams (e.g., using a configured AI/ML model). At 702, the WTRU predicts (e.g., periodically based on the parameter T_{BP}, or upon expiration of a timer) a beam quality measurement of a set of configured candidate beams (q̅₁). The beam quality measurement types for candidate beam determination may include one or more of: a PMI, CQ, RI, SINR, RSRQ, or L1-RSRP. It may be assumed that the beam predictions must be valid for a configured or determined duration (T_{d}). T_{BP} and T_{d} may be configured by the base station or determined by the WTRU (e.g., based on periodicity of Ψ₁).

At 703, the WTRU receives configuration information indicating beam quality measurement types and associated thresholds to use to determine a set of active candidate beam (e.g., via MAC-CE, RRC, or other logically equivalent signaling). At 704, the WTRU determines a set of active candidate beams based on predicted beam quality and configured measurement types/thresholds. The thresholds may be applied on individual configured candidate beams or on subset of configured candidate beams. The WTRU also indicates the determined set of active candidate beams (e.g., via MAC-CE as a bit map, via PRACH resource partitioning) to the base station.

At 705, the WTRU monitors for an indication from the base station configuring a set of monitored candidate beams. The WTRU may monitor at least one beam from the set of monitored candidate beams and determine a new candidate beam for beam failure recovery via CFRA-BFR. For example, the WTRU may monitor at least one selected candidate beam upon detection of a beam failure; periodic monitoring based on a configured periodicity; or network indication.

Some embodiments described herein may concern location based candidate set determination. An AI/ML model implemented, for example, at the base station or another network node may assist in predicting a WTRU's possible future location and appropriate candidate beams/beam sets based on WTRU's current location, WTRU's speed of movement, and the correlation with the movement of other WTRUs in the vicinity.

A WTRU ma be configured with a beam set q̅₁₋ₜₒₜₐₗ, subsets of candidate beams

$${\overline{q}}_{1}^{{R}_{i}} , i ∈ \{ 1 , 2 , … , N \} ,$$

and q̅_{1-remaining}. q̅₁₋ₜₒₜₐₗ may include all possible candidate beams. Candidate beam subset

$${\overline{q}}_{1}^{{R}_{i}}$$

may include candidate beams associated with position region

$${R}_{i} \cdot {\overline{q}}_{1 - union} = {⋃}_{i = 1}^{N} {\overline{q}}_{1}^{{R}_{N}} \cdot {\overline{q}}_{1 - remaining}$$

may include possible candidate beams that are not included in q̅₁₋ᵤₙᵢₒₙ. (q̅₁₋ₜₒₜₐₗ=q̅₁₋ᵤₙᵢₒₙ∪q̅_{1-remaining}).

The WTRU may receive beam resource and configuration information for position estimations/predictions. The WTRU may report to the station the position estimates/measurements/predictions. The WTRU may receive a candidate beam set for

$$B F R {\overline{q}}_{1}^{Active}$$

from the base station based on the reported positioning information.

The WTRU may receive a candidate beam set for

$$B F R {\overline{q}}_{1}^{Active}$$

(e.g., indicating the indices of a subset of

$${\overline{q}}_{1}^{{R}_{i}} , ∈ \{ 1 , 2 , … , N \} )$$

from the base station based on the positioning information estimated by the base station.

The WTRU may receive an indication of the association between subsets of candidate beams

$${\overline{q}}_{1}^{{R}_{i}} , i ∈ \{ 1 , 2 , … , N \}$$

and the position regions (Rᵢ, i∈{1, 2, . . . N}). The WTRU may determine its

$${\overline{q}}_{1}^{Active}$$

set based on its positioning information determined (i.e., position, speed, direction of motion) and the indicated association between its position and the candidate beam subsets

$${\overline{q}}_{1}^{{R}_{i}} .$$

WTRU may indicate its choice of

$${\overline{q}}_{1}^{Active}$$

by reporting its position information and/or index (indices) of the candidate beam subset(s)

$${\overline{q}}_{1}^{{R}_{i}}$$

to the base station (e.g., via MAC-CE, PUCCH, or transmitting a preamble associated with each

$${\overline{q}}_{1}^{{R}_{i}} ) .$$

The WTRU may start using

$${\overline{q}}_{1}^{Active}$$

for BFR subject to a start application time configured by the base station (e.g., X symbols/slots/milliseconds after the WTRU reports its positioning information/new

$${\overline{q}}_{1}^{Active}$$

to the base station). The WTRU may determine the length of application time for the

$${\overline{q}}_{1}^{Active}$$

set based on an accuracy threshold of position estimations (e.g., LoS probability).

The WTRU may receive a dynamic indication (e.g., a MAC-CE and/or DCI based indication, or another logical equivalent) to activate/de-activate positioning-based candidate beam set determinations. In some solutions, the WTRU may receive a dynamic indication (e.g., MAC-CE and/or DCI based) to activate/de-activate positioning-based candidate beam set determination. After receiving an activation indication, the WTRU may select a configured default candidate beam set

$${\overline{q}}_{1}^{Active} ( e . g . , {\overline{q}}_{1}^{Active} = {\overline{q}}_{1 - total} or a subset of {\overline{q}}_{1 - total} ( e . g . , {\overline{q}}_{1 - union} ) as its {\overline{q}}_{1}^{Active} set ) .$$

The WTRU may determine to follow a preconfigured fallback procedure for candidate beam selection under one or more of the following conditions. For example, when the accuracy of location estimations may fall below a predefined threshold, the WTRU the WTRU may switch to a fallback procedure if the LoS probability is less than a threshold, e.g., p_fallback. The WTRU may determine to follow a preconfigured fallback procedure if the quality (e.g., L1-RSRP) of all the beams in the currently active candidate beam set,

$${\overline{q}}_{1}^{Active}$$

determined to be lower than a threshold based on beam quality measurements by the WTRU. The WTRU may determine to follow a preconfigured fallback procedure if a measurement quality of positioning related signal (e.g., GNSS, PRS) falls lower than a predefined threshold. The WTRU may determine to follow a preconfigured fallback procedure if the WTRU's current position estimated by the base station conflicts with the WTRU determined

$${\overline{q}}_{1}^{Active}$$

The WTRU may determine to follow a preconfigured fallback procedure if the WTRU's current position goes out of bounds of all the position region sets or q̅₁₋ᵤₙᵢₒₙ set. The WTRU may determine to follow a preconfigured fallback procedure if the WTRU receives an explicit indication to follow fallback procedure through RRC/MAC-CE/DCI based indication.

When a WTRU is indicated or determines to select a fall back procedure for candidate beam selection, a WTRU may determine

$${\overline{q}}_{1}^{Active}$$

using one or more of the following solutions. The WTRU may include candidate beams from other position regions sets to its

$${\overline{q}}_{1}^{Active}$$

set (e.g., For example, if the current

$${\overline{q}}_{1}^{Active} = {\overline{q}}_{1}^{{R}_{3}} ,$$

then the WTRU may select a new

$${\overline{q}}_{1}^{Active} = {\overline{q}}_{1}^{{R}_{2}} ⋃ {\overline{q}}_{1}^{{R}_{3}} ⋃ {\overline{q}}_{1}^{{R}_{4}} ) .$$

The WTRU may select q̅₁₋ᵤₙᵢₒₙ as its

$${\overline{q}}_{1}^{Active}$$

set.

The WTRU may perform BFR (e.g., CFRA-BFR) using

$${\overline{q}}_{1}^{Active} .$$

The WTRU may monitor a quality (e.g., L1-RSRP) of beams in

$${\overline{q}}_{1}^{Active}$$

periodically or upon the detection of a beam failure/one or more beam failure instances for selecting a new beam. Candidate beam monitor periodicity may be configured by the base station or determined based on position information/accuracy of position estimations (e.g., LoS probability). The WTRU may monitor candidate beams based on at least one of the following events: the WTRU's direction of motion changes; LoS probability of the current beam falls below a configured threshold; or the speed of the WTRU is higher than a threshold. The WTRU may select a new beam based on beam measurements (e.g., beam with highest L1-RSRP or a beam with L1-RSRP higher than a preconfigured threshold). The WTRU may indicate beam failure and choice of new beam by transmitting preamble corresponding to the new beam and WTRU monitors BFR-CORESET for confirmation from the base station. The WTRU may repeat a preamble transmission process with increase transmit power if a confirmation of selection new beam is not received from the base station. If none of the beams in

$${\overline{q}}_{1}^{Active}$$

satisfies required beam quality measurements or WTRU fails to receive a new beam selection confirmation from the base station, WTRU may perform CBRA-BFR.

Some embodiments described herein may concern BFD-RS set determination. A WTRU may determine a BFD-RSs set q̅₀ out of a semi-static configuration RS set subject to availability determined by the WTRU. For example, the WTRU may be semi-statically configured with a set of RSs for BFD (e.g., 64 beams). The WTRU may dynamically indicate the availability of each RS for BFD (e.g., using a bit map) or a set of RSs (e.g., using a set index). The WTRU may monitor the recommended RSs (or RS sets) for BFD (where the BFD-RSs set q̅₀ is defined by both a semi-static configuration and dynamic indication) after receiving base station confirmation (e.g., receiving one or more of a PDCCH transmission, DCI or MAC-CE). The WTRU may monitor default BFD-RSs before recommending BFD-RSs and/or receiving the confirmation from the base station. For example, the WTRU may determine firstly/lastly configured N BFD-RSs among the configured BFD-RSs. For example, the WTRU may use RSs for QCL-Type D for PDCCHs/CORESETs/SearchSpaces. The WTRU may monitor the recommended BFD-RSs after recommending BFD-RSs and/or receiving the confirmation from the base station.

The WTRU may indicate other BFD related information in addition to the recommended BFD-RSs (e.g., the WTRU may indicate one or more of the following information): a monitoring periodicity and/or RS periodicity of BFD-RSs; a detection quality threshold (e.g., for detecting beam failure instance); a detection counter threshold (e.g., for detecting beam failure instance); a detection timer threshold (e.g., the WTRU may indicate a value for timer expiration for BFD); or a time offset and/or duration for BFD-RS activation/deactivation.

A base station may dynamically indicate (e.g., via one or more of DCI, MAC-CE, RRC signaling or another logical equivalent) one or more BFD-RSs with various information. For instance, a base station may dynamically indicate a monitoring periodicity (e.g., the base station may dynamically indicate the monitoring periodicity of BFD-RSs. The WTRU may adaptively select a BFD-RS monitoring periodicity based on the base station indication. If no signaling is received, the WTRU may monitor BFD-RSs based on the periodicity of BFD-RSs. When indicated by the base station, the WTRU may monitor BFD-RSs with different periodicity than the periodicity of BFD-RSs. For example, the WTRU may receive a one-bit indication to double the periodicity. The base station may dynamically indicate a detection quality threshold (e.g., for detecting beam failure instance). The base station may dynamically indicate a detection counter threshold (e.g., for detecting beam failure instance). In some cases, the base station may indicate a number for beam failure detection. The base station may dynamically indicate a detection timer threshold. For example, the WTRU may indicate a value for timer expiration for BFD. The base station may dynamically indicate a time offset and/or duration for BFD-RS activation/deactivation.

A WTRU may activate/deactivate BFD-RSs and/or associated BFD parameters (e.g., one or more of monitoring periodicity, detection quality threshold, detection counter threshold, detection timer threshold and time offset and/or duration for BFD-RS activation/deactivation) based on one or more of the WTRU's position, speed, direction of movement and correlation with the movement of other WTRUs in WTRU's vicinity. The WTRU may be configured with one or more IDs (e.g., zone IDs, direction IDs, speed IDs etc.,) and each ID may be associated with one or more BFD-RSs and/or associated BFD parameters. The WTRU may activate and deactivate one or more BFD-RSs and/or associated BFD parameters based on the one or more of WTRU's position, direction of movement, and speed.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a wireless transmit/receive unit (WTRU) for determining candidate beams for beam failure recovery, the method comprising:
receiving configuration information for receiving a first set of reference signals that are associated respectively with a first set of beams, configuration information for receiving a second set of reference signals that are associated respectively with a second set of beams, and one or more criteria for candidate beam selection;
receiving at least one of the first set of reference signals that are associated respectively with the first set of beams;
predicting beam quality measurements for the second set of reference signals that are based on beam quality measurements of the received at least one of the first set of reference signals; and
transmitting information indicating a selected third set of beams that satisfy the one or more criteria for candidate beam selection, wherein the selected third set of beams is a suggested set of candidate beams to be monitored for beam failure recovery, wherein the third set of beams is selected based on beam quality measurements of the received at least one of the first set of reference signals, and wherein the third set of beams is selected based on the predicted beam quality measurements for the second set of reference signal.

2. (canceled)

3. The method of claim 1, wherein beams of the second set of beams do not overlap with any one of the beams of the first set of beams.

4. The method of claim 1, wherein the first set of reference signals is associated with a first frequency range, and wherein the second set of reference signals is associated with a second frequency range.

5. The method of claim 1 further comprising receiving configuration information including an indication to monitor a fourth set of reference signals associated respectively with a fourth set of beams for beam failure recovery; monitoring at least one of the fourth set of reference signals; and transmitting a beam recovery request associated with at least one of the fourth set of beams.

6. The method of claim 4, wherein the fourth set of beams are different from the selected third set of beams.

7. The method of claim 4, wherein, based on the indication to monitor the fourth set of beams, the WTRU determines that the fourth set of beams is the same as the selected third set of beams.

8. The method of claim 1, wherein the criteria for candidate beam selection include at least one threshold value associated with a beam quality measurement type.

9. The method of claim 1, wherein the received configuration information includes an indication of one or more beam quality measurement types; and wherein the predicted beam quality measurements for the second set of reference signals are of the indicated one or more beam quality measurement types.

10. The method of claim 1 further comprising the WTRU periodically predicting beam quality measurements for the second set of reference signals upon expiration of a validity period.

11. A wireless transmit/receive unit (WTRU) configured to determine candidate beams for beam failure recovery, the WTRU comprising:
a processor; and
a transceiver;
the processor and the transceiver configured to receive configuration information for receiving a first set of reference signals that are associated respectively with a first set of beams, configuration information for receiving a second set of reference signals that are associated respectively with a second set of beams, and one or more criteria for candidate beam selection;
the processor and the transceiver configured to receive at least one of the first set of reference signals that are associated respectively with the first set of beams;
the processor configured to predict beam quality measurements for the second set of reference signals that are based on beam quality measurements of the received at least one of the first set of reference signals; and
the processor and the transceiver configured to transmit information indicating a selected third set of beams that satisfy the one or more criteria for candidate beam selection, wherein the selected third set of beams is a suggested set of candidate beams to be monitored for beam failure recovery, wherein the third set of beams is selected based on beam quality measurements of the received at least one of the first set of reference signals, and wherein the third set of beams is selected based on the predicted beam quality measurements for the second set of reference signal.

12. (canceled)

13. The WTRU of claim 10, wherein beams of the second set of beams do not overlap with any one of the beams of the first set of beams.

14. The WTRU of claim 10, wherein the first set of reference signals is associated with a first frequency range, and wherein the second set of reference signals is associated with a second frequency range.

15. The WTRU of claim 10, the processor and the transceiver further configured to receive configuration information including an indication to monitor a fourth set of reference signals associated respectively with a fourth set of beams for beam failure recovery; monitoring at least one of the fourth set of reference signals; and transmitting a beam recovery request associated with at least one of the fourth set of beams.

16. The WTRU of claim 13, wherein the fourth set of beams are different from the selected third set of beams.

17. The WTRU of claim 13, wherein, based on the indication to monitor the fourth set of beams, the processor is configured to determine that the fourth set of beams is the same as the selected third set of beams.

18. The WTRU of claim 10, wherein the criteria for candidate beam selection include at least one threshold value associated with a beam quality measurement type.

19. The WTRU of claim 10, wherein the received configuration information includes an indication of one or more beam quality measurement types; and wherein the predicted beam quality measurements for the second set of reference signals are of the indicated one or more beam quality measurement types.

20. The WTRU of claim 10, the processor configured to periodically predict beam quality measurements for the second set of reference signals upon expiration of a validity period.
